(19) United States
(12) Patent Application Publication
(10) Pub. No.: US 2025/0005334 A1
(43) Pub. Date: Jan. 2, 2025

(54) ANGLE BASED CONFIDENCE ESTIMATION FOR A NEURAL NETWORK USING CONDITIONALLY INFORMED PROBABILITY CONFIDENCE ESTIMATION

(71) Applicant: Government of the United States as represented by the Secretary of the Air Force, Wright-Patterson AFB, OH (US)

(72) Inventor: Patrick Kee, Bellbrook, OH (US)

(21) Appl. No.: 18/679,000

(22) Filed: May 30, 2024

Related U.S. Application Data
(60) Provisional application No. 63/510,983, filed on Jun. 29, 2023.

(51) Int. Cl. G06N 3/047; G06N 3/09

(52) U.S. Cl. CPC G06N 3/047; G06N 3/09

(57) ABSTRACT

A method of estimating the confidence in the output of a neural network. The method comprises providing data input to a neural network, splitting the data into two sets and training the neural network with weight and bias parameters. Plural decision vectors and plural weight vectors are paired to provide a like plurality of angle distributions. Labelled class parameters and predicted class parameters are computed and fitted to a parametric function. The parametric function is used to compute distribution parameters, which are used to compute probabilities that the values from the distribution parameters are correct. These probabilities can then be used to make a risk informed decision.

### CROSS REFERENCE TO RELATED APPLICATION

This application claims priority to and the benefit of provisional application Ser. No. 63/510,983 filed Jun. 29, 2023, the disclosure of which is incorporated herein by reference.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a method for estimating the confidence of a prediction and more particularly to such a method which is based on the geometric representation of the outputs of a neural network.

### BACKGROUND OF THE INVENTION

In 1943 McCulloch and Pitts published a comparison of neurons with a binary threshold to Boolean logic (i.e., 0/1 or true/false statements). In 1958 Rosenblatt is credited with the development of the perceptron, taking McCulloch and Pitt's work a step further by introducing weights to the equation. In 1974 Werbos suggested back propagation within neural networks. In the 1980's Hinton explored deep learning, comparing such process to functioning of the human brain with neurons having dendrites connected by axons or synapses. In 1989 LeCun illustrated how the use of constraints in backpropagation and integration fit into the neural network architecture to train algorithms. And in 1989 Bridle introduced the Softmax function, as an activation function, in an output layer of a neural network to improve training performance and as an estimate of likelihood of a correct classification decision. The Softmax function transforms the raw outputs of the neural network into a vector of probabilities, as a probability distribution over the input classes. As used herein the terms output layer and final layer are used interchangeably to refer to the last computational layer in the neural network.

A neural network is a machine learning process that uses interconnected nodes or neurons in a layered structure that resembles the human brain. Three common types of neural networks are Artificial Neural Networks (ANN), Convolutional Neural Networks (CNN) and the commonly used Recurrent Neural Networks (RNN). Multilayer Perceptron (MLP) is the classic ANN multilayer (deep) neural network, where each layer is fully connected with the preceding and following neural network. Neural networks solve problems that require pattern recognition. One of the most well-known neural networks is Google's search algorithm.

Neural networks are comprised of an input layer, a hidden layer or layers, and an output layer. Data are usually fed into these models to train them. Such models are currently the leading machine learning approach for solving problems in computer vision, natural language processing and speech recognition.

A neural network which passes data from one layer to the next layer is a feedforward network. Feedforward neural networks process data in one direction, from the input node to the output node. Every node in one layer is connected to every node in the next layer.

The feed forward algorithm begins with computing the values of the nodes of the input layer by computing the dot product between the values of the input layer and a weight vector associated with each node and adding a constant bias term. The weight vectors and bias terms are defined in a training process, where a training data set is used to compute output values, and the output values are compared to truth data, and the weight vectors are adjusted to minimize the disagreement (cost), between the predicted values and the truth data. Once the training is complete, the weight vectors and bias terms are fixed for subsequent use of the neural network classifier.

CNNs are a type of ANN commonly used for visual image recognition, pattern recognition, and/or computer vision. CNNs harness principles from linear algebra, particularly matrix multiplication, to identify patterns within an image. The hidden layers in CNNs perform specific mathematical functions, like summarizing or filtering, called convolutions. RNNs are identified by feedback loops. RNNs may use learning algorithms for time-series data to make predictions about future outcomes, such as stock market predictions or sales forecasting.

Each node, or artificial neuron, then connects to another node/neuron and has an associated weight and threshold. If the output of any individual node is above the specified threshold value, that node is activated, sending the associated data to the next layer of the network. Otherwise, no data will be passed along to the next layer of the network.

Neural networks rely on training data to learn and improve accuracy over time. Once these learning algorithms are fine-tuned for accuracy, they are powerful tools in computer science and artificial intelligence allowing one of skill to classify and cluster data at high velocity.

During use, each node can be set as a linear regression model composed of input data, weights, a bias (or threshold), and an output. Weights and biases are determinable from training. During this process, weights and biases may initially be randomly chosen, then when predictions are made based on those weights and biases, the difference between predictions and truth are compared, and an error value is computed by subtraction. The weights and biases are then adjusted using a gradient descent procedure to reduce error. Training can terminate when simultaneous predictions on a holdout “validation” data set indicates overfitting, and the weights and biases that produced the minimum error on the validation data set are used for production use.

Suitable formulae for computing node values in a revision general activation function are:

$$z = {Σ}_{i} {w}_{i} {x}_{i} + b = \vec{w} \cdot \vec{x} + b and$$

$$\hat{Y} = f ( z ) .$$

wherein z is the pre-activation node value, x is the vector of preceding layer node values, w and b are the weight vector and bias value for the node being calculated, Ŷ is the post-activation value, and f (z) is a non-linear function applied to the pre-activation node value, Z.

Referring to FIG. 1, weights 32 and bias terms are utilized to determine how a neural network 30 will make decisions. These weights 32 help determine the importance of any given variable, with larger ones contributing more significantly to the output compared to other inputs. The input value to an activation function is the weighted sum of the input values from the preceding layer in the neural network 30. All inputs are multiplied by their respective weights 32, then summed, and then the bias term is added to this sum. The resulting value is the input for the next step, the activation function. Once all of the activations for the first hidden layer 33H are computed, these values become the input layer 31 for computing the values for the next hidden layer 33H, and so on, until the output layer 34 is reached. The respective output is then passed through an activation function, which determines the appropriate output. There are four common types of activation functions: threshold functions, sigmoid functions, rectifier functions (ReLUs) and hyperbolic tangent functions.

Referring to FIG. 2A, threshold functions compute a different output signal depending on whether or not the input lies above or below a certain threshold. In a threshold activation function if the output exceeds a given threshold, the neural network 30 “fires” (or activates) the node, passing data to the next layer in the network.

Referring to FIG. 2B, the sigmoid function can accept any value, but always computes a value between 0 and 1. The sigmoid function may be used in logistic regression to solve classification problems.

Referring to FIG. 2C, the rectifier function is defined as if: the input value is less than 0, then the function outputs 0 and if not, the function outputs its input value.

Referring to FIG. 2D, the hyperbolic tangent function is based on a trigonometric identity with all output values shifted downward. ReLUs and hyperbolic tangents act, near a threshold value, so that sharp changes in output can result from small changes in input.

During training artificial neural networks 30 may learn by using corrective feedback loops to improve their predictive analytics. Data flows from the input nodes to the output nodes through many different paths in the neural network 30. But the only correct path is the one which maps the input nodes to the correct output node. To find this path, decision boundaries result from a series of weighted and non-linear calculations in each layer that leverage every activation value from the preceding layer, in the end resulting in one of the output nodes having the largest value. The input to the activation function, Xᵢ, is a vector in a vector space defined by a basis set of weight vectors. Thus the input is related to a respective weight vector by a respective angle ϕ.

Artificial neural networks 30 may learn by using a “backpropagation algorithm.” With the backpropagation algorithm, a cost function, which expresses the error between network predictions and true label values, is computed. Then the cost function is analyzed to determine which weights 32 and biases in the second to last layer contributed most to the error in output, and those values are adjusted. Then this adjustment process proceeds backwards through the network to the input layer 31, until all weights 32 and biases have been adjusted. This feedforward/backpropagation process may go through many cycles until the network is trained, usually determined when network accuracy does not improve when measured using a holdout dataset.

Referring to FIG. 3, per Waagen et al., the interaction between output of the decision space layer, X_{L-1}, and input weights 32 for the classification layer, w_{L}, can be thought of as the inner product plus a bias term, b. This relationship can be expressed as:

$${X}_{L} = {W}_{L} \cdot {X}_{L - 1} + b = {‖}_{{W}_{L}} {‖‖X}_{L - 1} ‖ cos ( ϕ ) + b ,$$

wherein the output layer 34, X_{L}, is a vector in a vector space defined by a basis set of weight vectors and it is related to each weight vector, wᵢ, by angle ϕᵢ. The angle ϕᵢ is determined by dot product as:

$${ϕ}_{i} = \frac{{Σ}_{j} {X}_{L - 1 , j} {w}_{i , j}}{{‖X}_{L - 1} {‖‖w}_{i} ‖} .$$

wherein X_{L-1,j} is the post-activation value of the j^{th} node of the decision layer, w_{i,j} is the j^{th} vector element of the weight vector for the i^{th} node, ∥X_{L-1}∥ is the magnitude of the decision vector, and |will is the magnitude of the weight vector for the i^{th} node. The dot product can also be expressed in geometric terms as the product of the magnitudes of the vectors, multiplied by the cosine of the angle, ϕᵢ, between the two vectors.

Following the computation of the dot product+bias term, this value is input into a non-linear function. Exemplary non-linear functions in widespread use in machine learning include the logistic function, the hyperbolic tangent function, and the rectified linear unit (or ReLU) function. The final layer 34 typically employs the Softmax function. These non-linear functions are necessary for creating complex boundaries needed to accurately classify input data. The output of the non-linear function is called the “activation” of the node. These nonlinear functions scale outputs between 0 and 1 to be closer to truth values to make training easier, and to give an approximate confidence estimate to the use. One of skill can then represent the final layer 34 of the network as a decision space with an input vector x and class vectors based on the weight vector of that neuron.

Many multi-layer neural networks 30 have a terminal layer which outputs real-valued scores that are not conveniently scaled and which may be difficult to work with. In the prior art, a Softmax function is often used to convert these scores to a normalized probability estimate. The Softmax function may be given by:

$$Softmax = \frac{{e}^{x} i}{{Σ}_{k} {e}^{x} k} where P ( y = i \vert x ) = \frac{{e}^{x} i}{{Σ}_{k} {e}^{x} k} ] .$$

Particularly, the Softmax function suffers from the deficiency of overestimating the confidence in a prediction. A study by the Air Force Research Laboratory showed that for a neural network 30, predictions made at 98% confidence had an error rate of 10%. This type of error is possible because the Softmax function was developed such that it provided an optimized probability estimate over the entire distribution. So systematic errors in one region of the distribution are possible, even if the errors are balanced by systematic errors in a different region of the distribution. These errors are seen in practice, where systematic overestimation occurs at high probability, and significant underestimation occurs at low probability.

One attempt in the prior art to compensate for the Softmax function problems was to calibrate the neural network 30 using a “temperature” scaling parameter to improve performance according to scale the Softmax function=e^{βz}^{ᵢ}/Σₖe^{βz}^{ₖ}. e^{βz}^{ᵢ}/Σₖe^{βz}^{ₖ} The reference to temperature is because of the apparent similarity to the Boltzmann Population Distribution developed by Ludwig Boltzmann in 1868:

$$P ( {E}_{j} ) = \frac{{n}_{j} exp ( - {E}_{j} )}{{Σ}_{i} {n}_{i} exp ( - {E}_{i} )}$$

wherein Eᵢ is the energy, and nᵢ is the degeneracy of the i^{th} thermodynamic state.

The terms in the Softmax function exponentials are positive, while those in the Boltzmann exponentials are negative. Despite this difference, many authors in the prior art mistakenly refer to the Softmax function as being the Boltzmann Population Distribution, and use this similarity to justify use of the Softmax function or estimating probabilities.

However, even these improvements do not address a longstanding and important weakness in the Softmax function dating back to British radar scientist John Bridle's original paper, particularly that all classes of objects being predicted occur with the same frequency. The Softmax function also fails to address network performance in terms of probability of correct classification is ultimately estimated based on training data, when it is best practice in machine learning to estimate performance using data that has not been used to train the network. The object of the present invention is to overcome these longstanding and important deficiencies in the original Softmax function.

### SUMMARY OF THE INVENTION

In one embodiment the invention comprises a method of estimating the confidence in a neural network. The method comprising the steps of: defining a problem to be solved using a neural network; providing data to be input to the neural network; splitting the data into a training data set, and a test data set, the test data set and the training data set being mutually exclusive; splitting a validation data set from the training data set, the validation data set and the training data set being mutually exclusive; training the neural network to have weight parameters and bias parameters to minimize plural aggregate differences between at least one prediction from the neural network and at least one truth datum contained within the training data set; determining a decision plurality of decision vectors and a weight plurality of weight vectors; pairing individual decision vectors from the decision plurality of decision vectors with corresponding individual weight vectors from the weight plurality of weight vectors; computing angle distributions between the individual decision vectors and the corresponding individual weight vectors; computing a combination of labelled class parameters and predicted class parameters from the angle distributions; fitting a parametric function to a histogram of the angle distributions for each combination of labeled class parameters and predicted class parameters; computing distribution parameters from the parametric function; estimating probabilities from the distribution parameters that the neural network predictions are correct; computing probabilities that the values from the distribution parameters are correct; and using the probabilities to provide a human or machine decision maker with the likelihood information about the neural network's prediction needed to make a risk informed decision.

In one embodiment the invention comprises a method of estimating the confidence in a neural network. The method comprising the steps of: defining a problem to be solved using a neural network; providing data to be input to the neural network; splitting the data into a training data set and a test data set, the test data set and the training data set being mutually exclusive; splitting a validation data set from the training data set, the validation data set and the training data set being mutually exclusive; training the neural network to have weight parameters and bias parameters to minimize plural aggregate differences between at least one prediction from the neural network and at least one truth datum contained within the training data set; determining a decision plurality of decision vectors and a weight plurality of weight vectors; pairing individual decision vectors from the decision plurality of decision vectors with corresponding individual weight vectors from the weight plurality of weight vectors; constructing a data structure consisting of decision vector orientations, specified by angles relative to weight vectors, for input data from a validation data set neither used for training or testing the neural network; determining which decision vectors in the data structure are within a specified spatial neighborhood of a test or operational data decision vector under evaluation; estimating Bayesian probabilities from class counts of vectors in the data structure and prior class distributions that the neural network predictions are correct; and using the probabilities to provide a human or machine decision maker with the likelihood information about the neural network's prediction needed to make a risk informed decision.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a general neural network according to the prior art.

FIG. 2A is a threshold function according to the prior art.

FIG. 2B is a sigmoid function according to the prior art.

FIG. 2C is a rectifier function according to the prior art.

FIG. 2D is a hyperbolic tangent function according to the prior art.

FIG. 3 is the decision vector according to the prior art shown in vector space.

FIG. 4 is a neural network usable with the present invention.

FIG. 5 is a geometric representation of the outputs of a neural network.

FIG. 6 is a graphical representation of an activation function according to a first embodiment of the present invention in a vector space.

FIG. 7 is a flow chart of a process diagram according to the present invention.

FIG. 8 is a frequency distribution of angles relative to output class 5 for matching class 5 and non-matching class 0 with parametric probability density functions fit for the matching class (Log-Normal distribution) and non-matching class (Cauchy distribution) angle distributions.

FIG. 9 illustrates computation of a probability from integration of a probability density function over a finite range.

FIG. 10 is a graphical representation of the second embodiment of the invention.

FIG. 11A is a graphical comparison of the adaptive calibration errors for the Softmax function and BACON according to the present invention at about 85% accuracy.

FIG. 11B is a graphical comparison of the adaptive calibration errors for the Softmax function and BACON according to the present invention at about 95% accuracy.

FIG. 11C is a graphical comparison of the adaptive calibration error at about 95% confidence intervals for the Softmax function and BACON according to the present invention.

FIG. 12A is a graphical comparison of the adaptive calibration errors for the Softmax function and CIPCE according to the present invention at about 85% accuracy.

FIG. 12B is a graphical comparison of the adaptive calibration errors for the Softmax function and CIPCE according to the present invention at about 95% accuracy.

FIG. 12C is a graphical comparison of the adaptive calibration error at about 95% confidence intervals for the Softmax function and CIPCE according to the present invention.

FIG. 13A1 is a graphical representation of the adaptive calibration error for BACON and weighted BACON according to the present invention at about 85% accuracy.

FIG. 13A2 is a graphical representation of the expected calibration error variances for BACON and weighted BACON according to the present invention at about 85% accuracy.

FIG. 13B1 is a graphical representation of the adaptive calibration error for BACON and weighted BACON according to the present invention at about 95% accuracy.

FIG. 13B2 is a graphical representation of the expected calibration error variances for BACON and weighted BACON according to the present invention at about 95% accuracy.

FIG. 14A1 is a graphical representation of the adaptive calibration error for CIPCE and weighted CIPCE according to the present invention at about 85% accuracy.

FIG. 14A2 is a graphical representation of the adaptive calibration error variances for CIPCE and weighted CIPCE according to the present invention at about 85% accuracy.

FIG. 14B1 is a graphical representation of the adaptive calibration error for CIPCE and weighted CIPCE according to the present invention at about 95% accuracy.

FIG. 14B2 is a graphical representation of the adaptive calibration error variances for CIPCE and weighted CIPCE according to the present invention at about 95% accuracy.

FIG. 15 is a graphical comparison of the adaptive calibration errors for the Softmax function and weighted BACON for individual classes over a range of accuracies.

FIG. 16 is a graphical comparison of the adaptive calibration errors for the Softmax function and weighted CIPCE for individual classes over a range of accuracies.

FIG. 17 is a flow chart of a process according to the present invention using BACON.

FIG. 18 is a flow chart of a process according to the present invention using BACON.

FIG. 19 is a flow chart of a process according to the present invention using BACON.

FIG. 20 is a flow chart of a process according to the present invention using CIPCE.

FIG. 21 is a flow chart of a process according to the present invention using CIPCE.

FIG. 22 is a flow chart of a process according to the present invention using CIPCE.

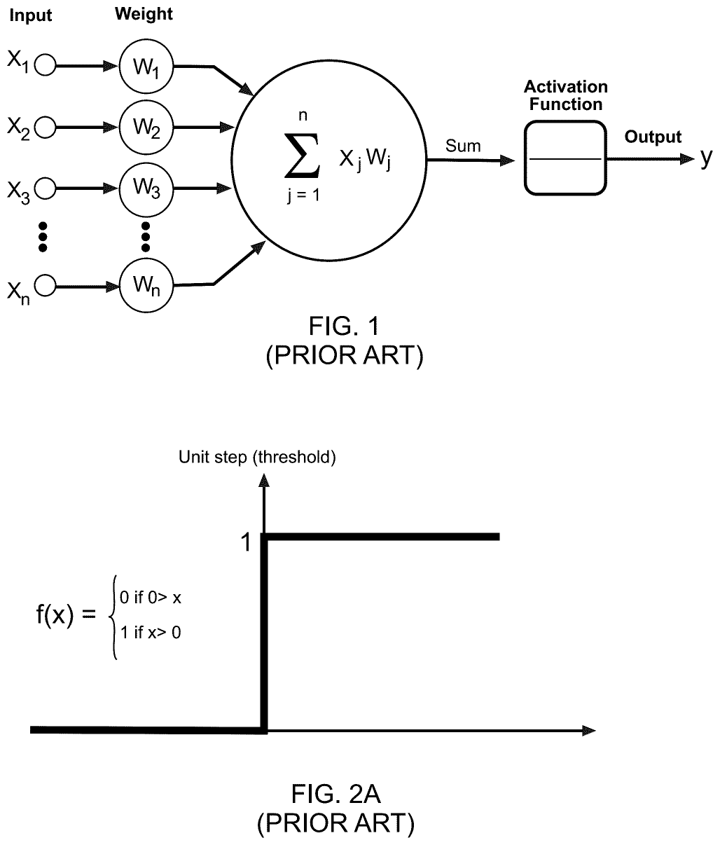

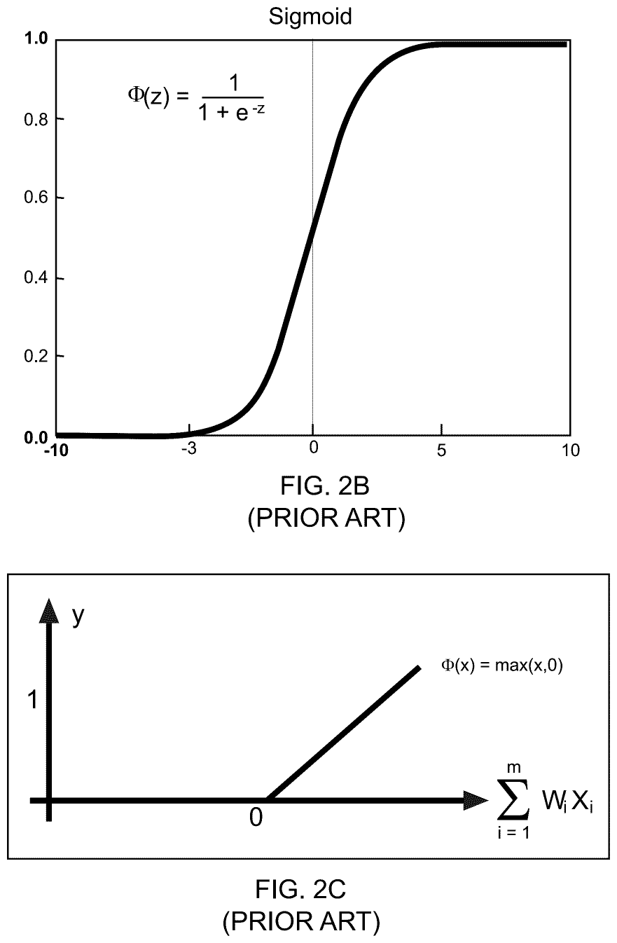

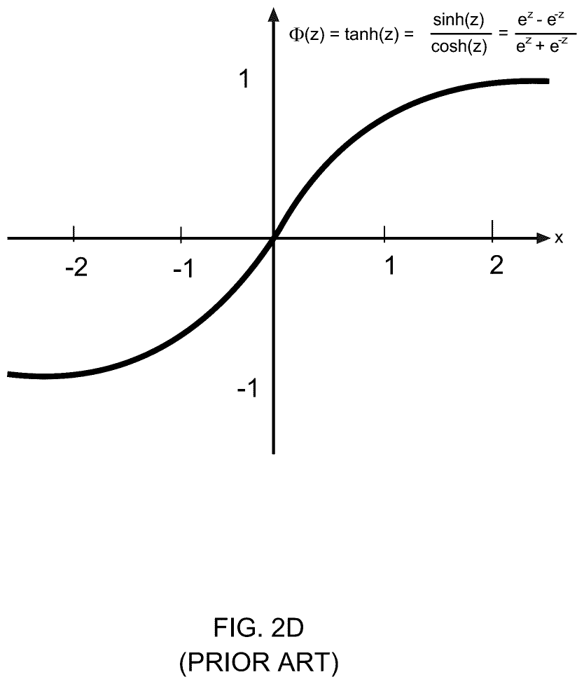

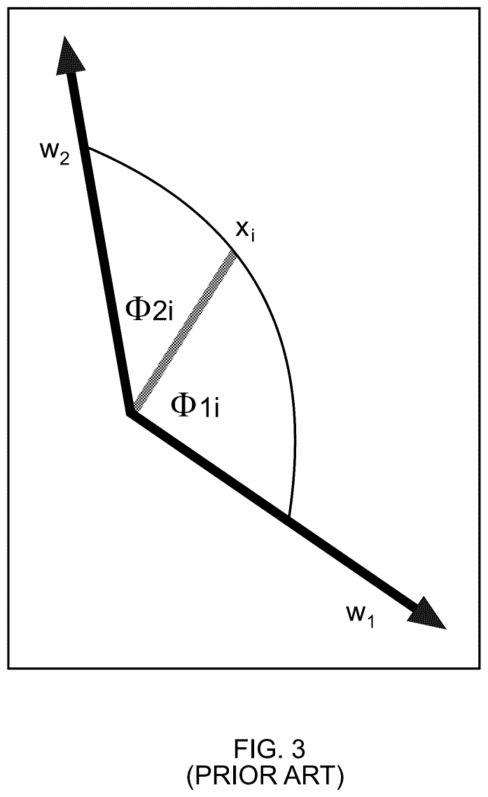

### DETAILED DESCRIPTION OF THE INVENTION

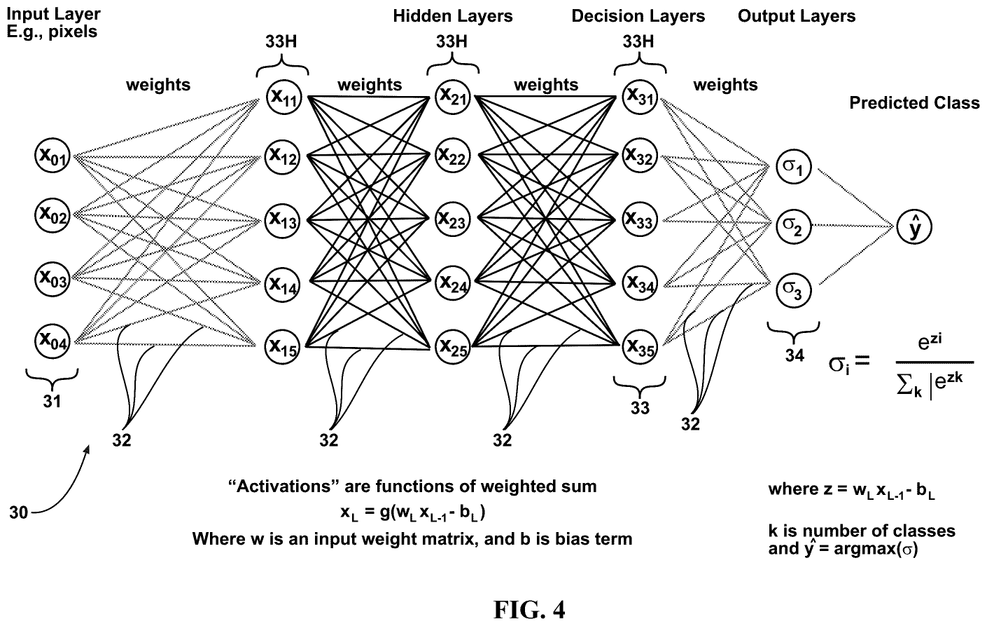

Referring to FIG. 4, a neural network 30 usable with the present invention has an input layer 31 with a determinate plurality of nodes, one or more hidden layers 33H with determinate pluralities of nodes and an output layer 34 with at least two nodes. Each layer after the input layer 31 has weights 32 associated with each node in the layer, where the total number of weights 32 is equal to the number of nodes in the preceding layer. The weights 32 belong to each node in each layer after the input layer 31, and the number of weights 32 for each node is equal to the number of nodes in the preceding layer. The determinate pluralities may be unequal or mutually equal in whole or in part.

The input values are arrayed in a line of nodes on the left hand side of the figure, and these nodes contain the input values. The output nodes for each class are in the layer marked “output” layer, and the node with the largest value becomes the predicted class.

According to the present invention, the estimation is based on the geometric representation of the outputs of the neural network 30. The output of neural network 30 is represented as a vector in an n-dimensional space (where n is the number of possible output classes). The decision vector is defined as the decision layer 33 node activation values. And the values of the output layer 34, resulting from the dot product between the decision vector and output node weight vectors plus a bias term, can be considered a projection of the decision vector on the output class vectors, if the bias term is omitted. Smaller angles between decision and output vectors generally indicate a greater likelihood of the class being correct. The confidence is calculated for each class by determining the likelihood a decision vector in a given position belongs to a class.

A neural network 30 classifier 44 transforms a set of input values, such as the intensities of pixels in an image, into a numerical value for each possible class that the neural network 30 classifier 44 will choose from. The class with the largest number associated with it becomes the predicted class. The problem solved by the present invention is to estimate the likelihood that this prediction is the correct answer.

To transform the input values into the values for the output layer 34, a series of affine and non-linear transformations are performed in a number of “hidden layers 33H” between the input layer 31 and output layer 34. Affine is the initial step, i.e. the dot product of input layer 31 with weights 32 of next layer, plus the bias term. Without the bias term, it would be a linear transformation. This transformation process is called a feedforward algorithm.

The feed forward algorithm begins with computing the values of the nodes of the first hidden layer 33H by computing the dot product between the values of the input layer 31 and a weight vector associated with each node and adding a constant bias term. The weight vectors and bias terms are defined in a training process, where a training data set 40, with a training data subset 41, is used to compute output values, and the output values are compared to truth data, and the weight vectors are adjusted to minimize the disagreement (cost), between the predicted values and the truth data. Once the training is complete, the weight vectors and bias terms are fixed for subsequent use of the neural network 30 classifier 44.

Following the computation of the dot product+bias term, this value is input into a non-linear function. Example non-linear functions in widespread use in machine learning include the logistic function, the hyperbolic tangent function, and the rectified linear unit (or ReLU) function. These non-linear functions are necessary for creating complex boundaries needed to accurately classify input data. The output of the non-linear function is called the “activation” of the node.

Once all of the activations for the first hidden layer 33H are computed, these values become the input layer 31 for computing the values for the next hidden layer 33H, and so on, until the output layer 34 is reached. In computing the output layer 34, following computation of the dot product plus bias for each node, the Softmax function is used as the activation function. Then the class corresponding to the node with the largest Softmax function value is reported as the predicted class. If a user is using the Softmax function to compute confidence, the Softmax function value for this node is reported as the probability of correct classification.

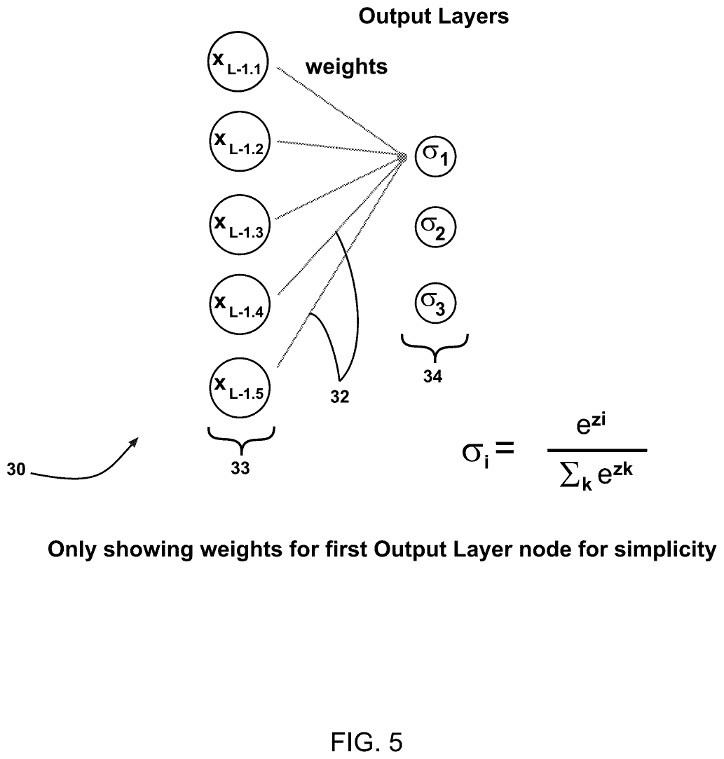

Referring to FIG. 5, the final two layers of the neural network 30, the output layer 34, and the preceding hidden layer 33H, which referred to herein as the “decision layer”. The decision layer 33 contains all of the information that is needed to make a classification decision, since its node values are used to compute the pre-activation values of the output layer 34 nodes. The weights 32 and bias terms of the output nodes are determined during training.

Thus the decision vector can be treated as a “state vector” for the neural network 30 classifier 44. Then the matter of computing the probability that a particular decision layer 33 vector belongs to a specific class can be restated as the probability that the angles corresponding to this vector correspond to a particular class.

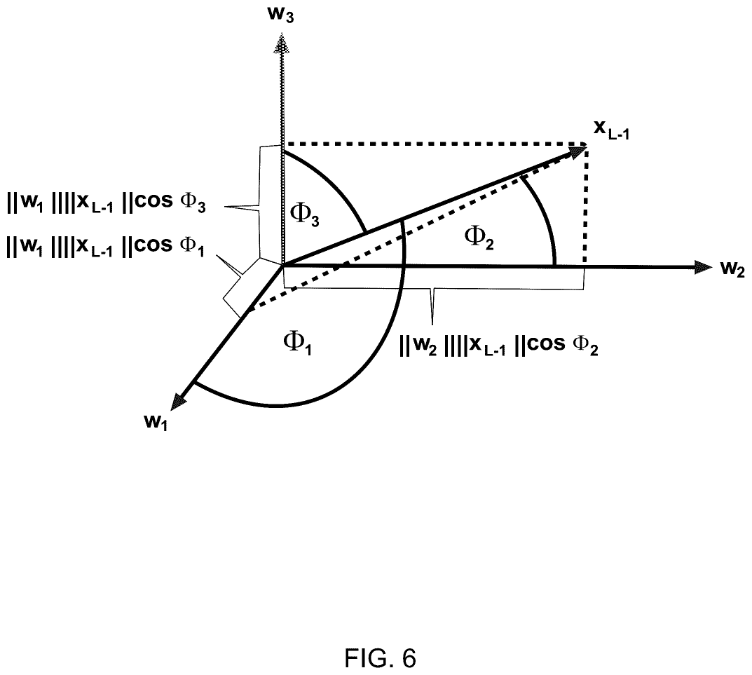

Referring to FIG. 6, each node is computed from the dot product of the decision layer 33 with the weight vector for the node, plus a bias term according to:

wherein zᵢ is the pre-activation value of output node “i”. This value is input to the Softmax

$${z}_{i} = \vec{{w}_{i}} \cdot \vec{{x}_{L - 1}} + b$$

function to compute the final output value.

A dot product can also be expressed in geometric terms as the product of the magnitudes of the vectors, multiplied by the cosine of the angle, φi, between the two vectors:

$$\vec{{w}_{i}} \cdot \vec{{x}_{L - 1}} = ‖ \vec{{w}_{i}} ‖ ‖ \vec{{x}_{L - 1}} ‖ cos {φ}_{i}$$

wherein the angle, φi, can be solved for algebraically:

$${φ}_{i} = {cos}^{- 1} ( \frac{\vec{{w}_{i}} \cdot \vec{{x}_{L - 1}}}{‖ \vec{{w}_{i}} ‖ ‖ \vec{{x}_{L - 1}} ‖} )$$

Each output node, i, has a corresponding angle, φᵢ. The outputs of a neural network 30 in can be shown in a geometric representation.

In the geometric representation, the orientation of the decision layer 33 vector is related to the class weight vectors by the included angles. The output layer 34 values, before applying the Softmax function, and minus the bias term, are the projection of the decision layer 33 vector onto the weight vector for each class. Smaller angles between the decision and weight vectors generally indicate a greater likelihood of the class being correct. In the output layer 34, the dot products of the decision layer 33 activation values with the weights 32, as determined during training, of each output node to get the node values. Then these values are input to the Softmax function. One of skill can represent the final layer 34 of the network as a decision space with an input vector x and class vectors based on each class's neuron's weight vector.

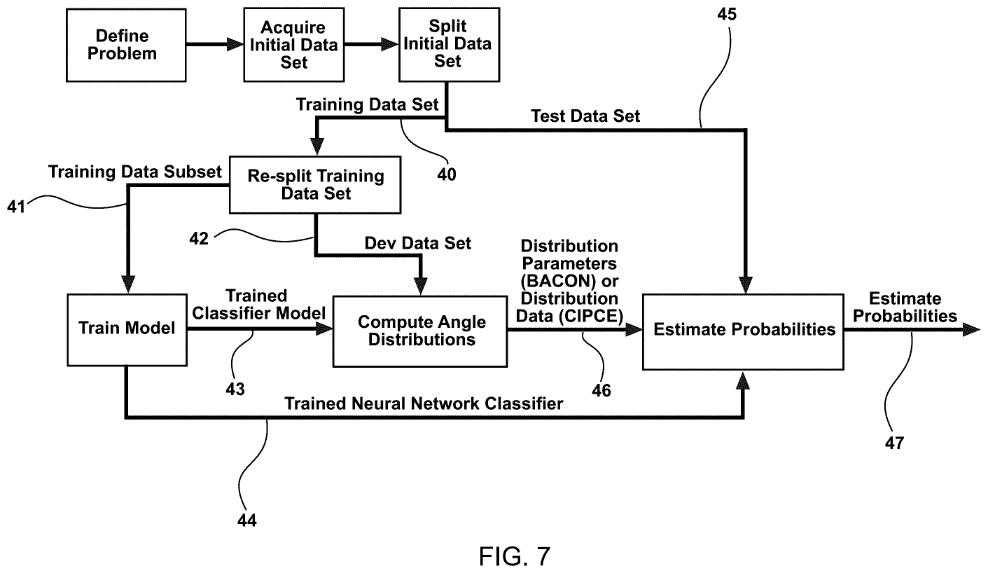

Referring to FIG. 7, Angle Based Confidence Definition and Estimation according to the present invention provides two methods for computing this probability: 1) Bayesian Confidence Estimation (BACON); and 2) Conditionally Informed Probability Confidence Estimation (CIPCE).

In a first embodiment the probability is computed by using either a Bayesian Confidence Estimation (BACON) or, in a second embodiment, the probability is computed by using the Conditionally Informed Probability Confidence Estimation (CIPCE), using the angles associated with the output vector as inputs to the calculation.

Then knowing the angle, the present invention uses BACON or CIPCE, as independent embodiments to estimate the confidence, as a probability according to Bayes' Rule:

$$P ( A \vert B ) = \frac{P ( B \vert A ) P ( A )}{P ( B )} .$$

Bayes' Theorem states that the conditional probability of an event, based on the occurrence of another event, is equal to the likelihood of the second event given the first event multiplied by the probability of the first event, divided by the probability of the second event. The conditional probability can be restated as the probability of one event given the occurrence of another event, often described in terms of events A and B from two dependent random variables e.g. X and Y. The joint probability is the probability of two (or more) simultaneous events, often described in terms of events A and B from two dependent random variables, e.g. X and Y. The conditional probability can be calculated using the joint probability as given by P(A|B)=P(A, B)/P(B), wherein the result P(A|B) may be referred to as the posterior probability and P(A) referred to as the prior probability.

There are separate embodiments for BACON and CIPCE. For BACON, Bayes' Theorem is expressed as:

$$P ( j \vert {ϕ}_{j} ) = \frac{{N}_{j} {\int }_{2 Δ} {f}_{j j} ( {ϕ}_{j} ) d {ϕ}_{j}}{{Σ}_{k} {N}_{k} {\int }_{2 Δ} {f}_{j k} ( {ϕ}_{j} ) d {ϕ}_{j}} .$$

Here, the term: ∫_{Δ} fⱼⱼ(ϕⱼ)dϕⱼ, is the probability, P(ϕⱼ|j), that angle ϕⱼ is measured if j is the labeled class. The term fⱼⱼ(ϕⱼ) is the value of the probability density function (PDF) for the angle relative to class j, when class j is the labeled class.

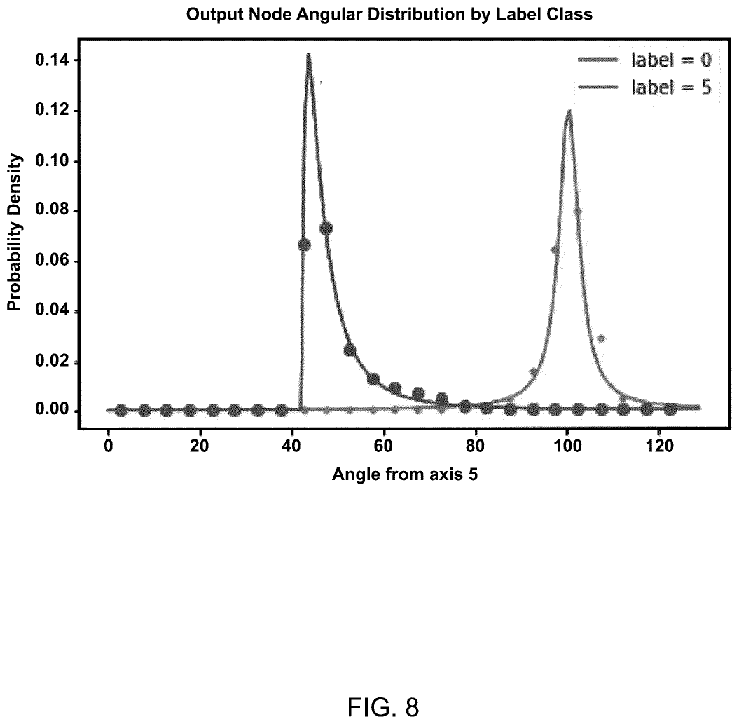

Referring to FIG. 8, the PDF is obtained by fitting a parametric distribution to a histogram of computed angles from a holdout dataset run through the trained neural network 30. A parametric function such as the Log-Normal or Cauchy distributions may be used to fit the histogrammed angle data.

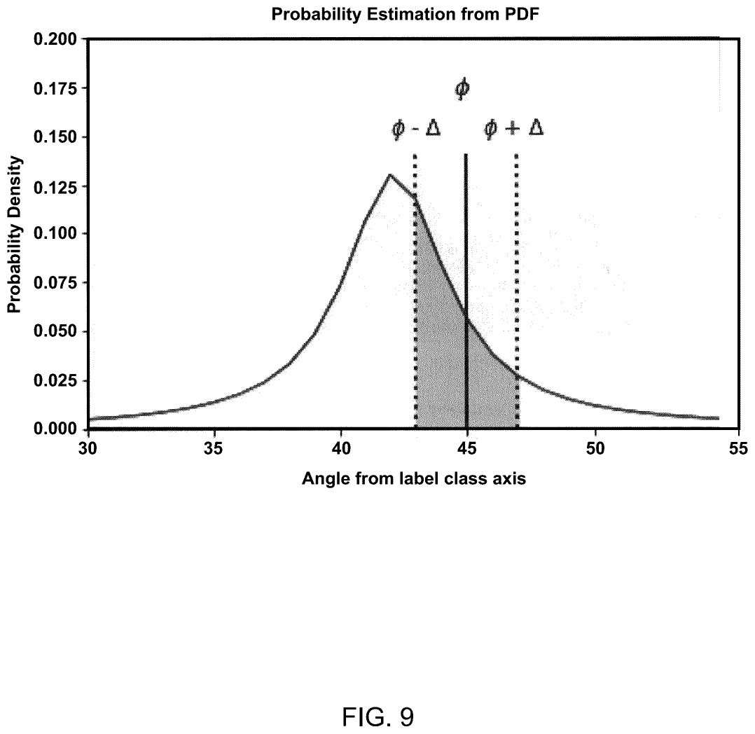

Referring to FIG. 9, to estimate the probability, P(ϕⱼ|j), the next step is to integrate the pdf for a finite interval in the neighborhood of ϕⱼ. This pdf is equivalent to, and simpler to execute in practice, by differencing the cumulative distribution function (cdf) values at the ends of the interval. The path length, Δ, is optimized using a holdout dataset to provide best calibration performance compared to truth probabilities.

The other term in the numerator, Nⱼ, for Bayes' Rule in BACON is the expected class fraction for class “j” (i.e., what fraction of all data points are expected to be class j). Here the term Nⱼ provides BACON the capability to explicitly handle imbalanced test sets, while the Softmax function has no such capability. The importance and significance of this capability according to the present invention is seen in the hypothetical problem of discriminating between tanks and school buses. The likelihood of encountering one or the other depends upon, e.g., whether imagery is collected over Fort Knox (a military training facility for armored military units having tanks) or Louisville, Kentucky (a population center with many school aged children and school busses).

The denominator term computes the total probability that the angle øj is observed across all labeled classes. This denominator is a weighted sum over all classes of the probability that angle ϕj is observed for that class. Weights, Nₖ, are the expected class ratio for class k, fⱼₖ(ϕⱼ) is the value of the PDF for the angle relative to class j when class k is the labeled class. PDFs are computed as for the term in the numerator, and integration is performed as previously described, by differencing CDF values at the endpoints of integration.

In a second embodiment, CIPCE also uses angle geometry to estimate confidence (probability) as a function of the computed angles. Unlike BACON, which used a single angle, CIPCE uses the entire vector of angles to estimate confidence using Bayes' Rule.

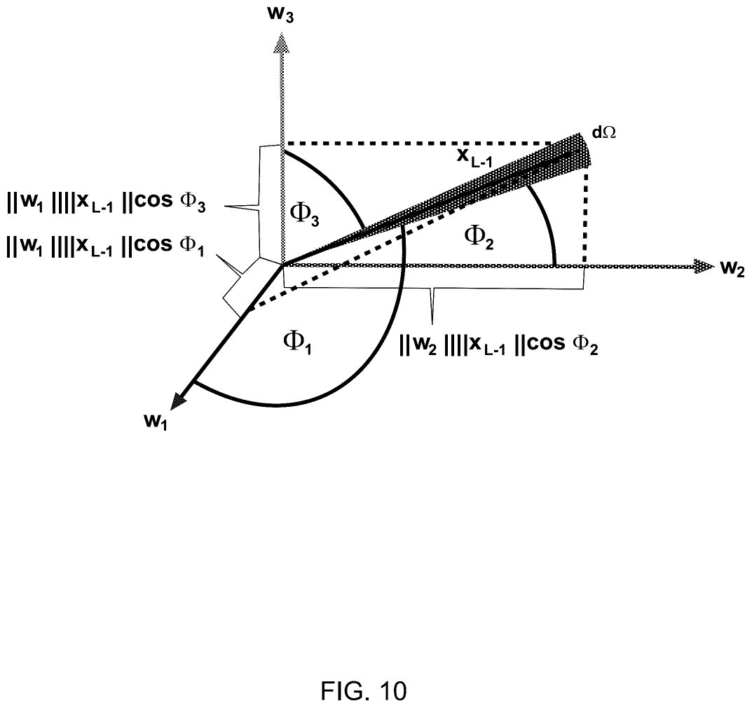

Referring to FIG. 10, conceptually, CIPCE uses the angles to define a vector in space. A margin of is defined around the vector in space to define a solid angle, do. Then Bayes' rule can be expressed as:

$$P ( j , d Ω ) = \frac{P ( d Ω , j ) P ( j )}{P ( d Ω )} .$$

wherein P(dΩ, j) is the probability of vector of class label “j” from a balanced class distribution being found within solid angle dΩ, P(j) is the expected class fraction belonging to class j, and P(dΩ) is the total probability that a vector of any class will be found within solid angle dΩ. This equation can be more usefully be expressed as:

$$P ( j , d Ω ) = \frac{{f}_{d {Ω}_{j}} {N}_{j}}{{Σ}_{k} {N}_{k} {f}_{d {Ω}_{k}}} .$$

wherein the numerator, f_{dΩj}, is the fraction of vectors from the balanced class distribution validation data set 42, interchangeably referred to herein as a dev data set 42, lookup table that fall within solid angle dΩ belong to class j and Nⱼ is the estimated class fraction for class j in the problem being analyzed. In the denominator, there is a sum over all classes of the products of Nₖ, the class fraction for the k^{th} class, with f_{dΩ}_{ₖ}, and the fraction of vectors from the balanced class distribution validation data set 42 lookup table that fall within solid angle dΩ which belong to class k. In a less preferred formulation, this expression for CIPCE can be interpreted as a weighted average of the fraction of vectors within dΩ that belong to class j.

This initial formulation of CIPCE may experience a problem in the case where a test vector may exist in a region where there are few or no vectors within the solid angle dΩ in the validation set lookup table. This formulation may result in noisy misleading results, or even a divide-by-zero error during computation.

In a more preferred formulation, to mitigate this problem, one of skill may add 1 to the count for all classes in both the numerator and denominator yielding the expression:

$$P ( j , d Ω ) = \frac{( 1 + {f}_{d {Ω}_{j}} ) {N}_{j}}{{Σ}_{k} {N}_{k} ( 1 + {f}_{d {Ω}_{k}} )} .$$

This revised expression ensures that probability estimates will trend towards the uniform distribution (for the unweighted case) or the weight distribution (for the weighted case) for the case of few or no vectors within dΩ in the validation data set 42 lookup table.

An alternative method for addressing the problem of few or no vectors in the lookup table is to use either the uniform probability or class weight associated with the output node whenever there are not enough vectors in the lookup table for the test condition (e.g., n<n_{threshold}) to provide a reasonable probability estimate.

Referring to FIG. 5, in operation, the sequence of steps is:

Define problem: The classification problem is defined. Specifically, this means defining the type of data input (e.g., images), and classes that are present in the input. A neural network 30 classifier model 43 (e.g., VGG-16, ResNet-18, etc. . . . ) is selected.

Get Data: Data are obtained for training and testing purposes. The data should be as representative as possible to the operational problem. And the data preferably include “truth” (i.e., correct class labels). Preferably, classes are equally represented in the dataset.

Split Data: The data are randomly split into a “Training” data set and a “Test” data set. The test data set 45 is sequestered until it is time to evaluate model performance. Sequestration is done to ensure model evaluation results can be generalized to operational data the model has not encountered in training. The test data size is chosen to ensure sufficient statistical accuracy to meet evaluation objectives. The balance of the data is used in the training data set 40.

Re-split training data: The training data set 40 is re-split into a “Training” and a “Dev” (sometimes called “Validation”) data set. The purpose of the Dev data set is to conduct initial model evaluation to provide feedback to model design, preserving the Test data set for final model evaluation. In addition, the Dev data set will be used to provide angle distributions for calculating BACON and CIPCE confidence estimates.

Train Model: The weight and bias parameters of the neural network 30 model are adjusted to minimize the aggregate difference (“loss”) between the neural network 30 predictions and the truth data for the training set. Typically, “loss” is expressed as the cross-entropy loss, and the optimization of weight and bias parameters may be performed using a gradient descent (e.g., stochastic gradient descent) technique. The optimization process conducts gradient descent using training data and evaluates loss using both training data set 40 and dev data set 41. The training is terminated when loss values for the dev set reach a minimum value to avoid overfitting the model.

Compute Angle Distributions: Once the neural network 30 classifier model 43=is trained, the dev set is used to compute angle distributions. The BACON algorithm will fit a parametric function (e.g., Cauchy distribution) to a histogram of angles for each combination of labeled class and predicted class, and the parameters will be saved in a data structure for later reference. The CIPCE algorithm will use the resulting angle distribution data set consisting of labeled class, and angles for each class.

Estimate Probabilities: Probabilities are then computed from the saved distribution parameters 46 (BACON algorithm) or the angle distribution data set (CIPCE algorithm) and reported. This step is initially conducted using test data. When the neural network 30 model, with associated angle distributions, are accepted for operational use this step can be performed using empirical operational data to predict probabilities.

Knowing the estimated probabilities 47, these values can be used as follows. For the simplest case, the estimated probabilities 47 can be used to support human decision-making. The decision making process requires management of risk, which has two components: likelihood and consequence. Consequences of decisions are usually well-understood, while likelihood is less so. This invention is believed to improve the human decision-makers' understanding of likelihood in the risk management process by providing improved estimation of outcomes. For example, a physician will understand the consequence of whether a spot on an x-ray for the cases of a malignant tumor, as well as for a benign mass. However, that physician will not be able to interpret the raw output of the neural network 30 that found the spot on the x-ray to determine the likelihood of cancer. This invention overcomes the problem of providing the likelihood information needed by the human decision maker to make a risk informed decision.

A second use case is in multi-stage decision processes. A decision maker often has to rely on multiple sources of information. To make a decision that manages risk, likelihood information must be obtained from all sources of information, with that information fused in a way such that a new overall likelihood estimate would be derived that includes likelihood information provided by the first stage of the process. For example, prophetically a physician using multiple medical imaging techniques to diagnose a disease (e.g., MRI and CT scan) could use the present invention to improve patient outcomes. Particularly, a neural network 30 could be used to analyze the data, and provide an initial likelihood estimate using this invention, and these estimates would be provided to an information fusion process to provide an overall likelihood estimate to the physician using all sources of information.

In both of these use cases, the present invention is expected to lead to improvements to the practice of making risk informed decision making processes by providing improved confidence estimates (AKA ‘probabilities’ or ‘likelihoods) in the classification decisions made by neural networks 30 that will be used by human or machine decision makers.

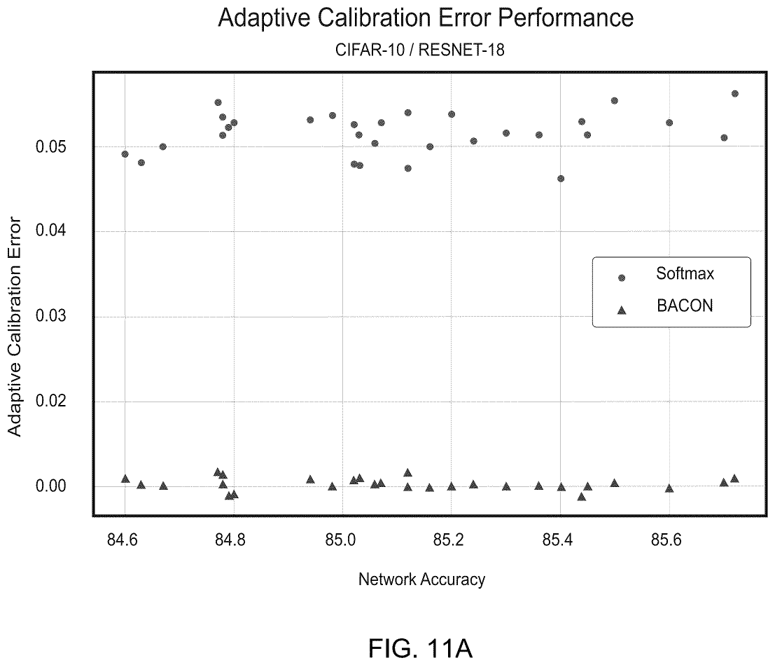

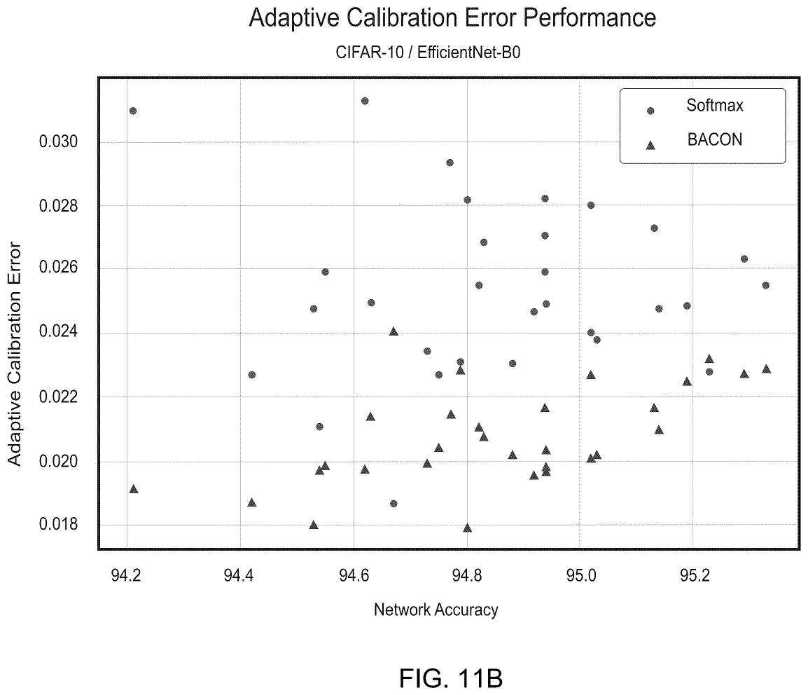

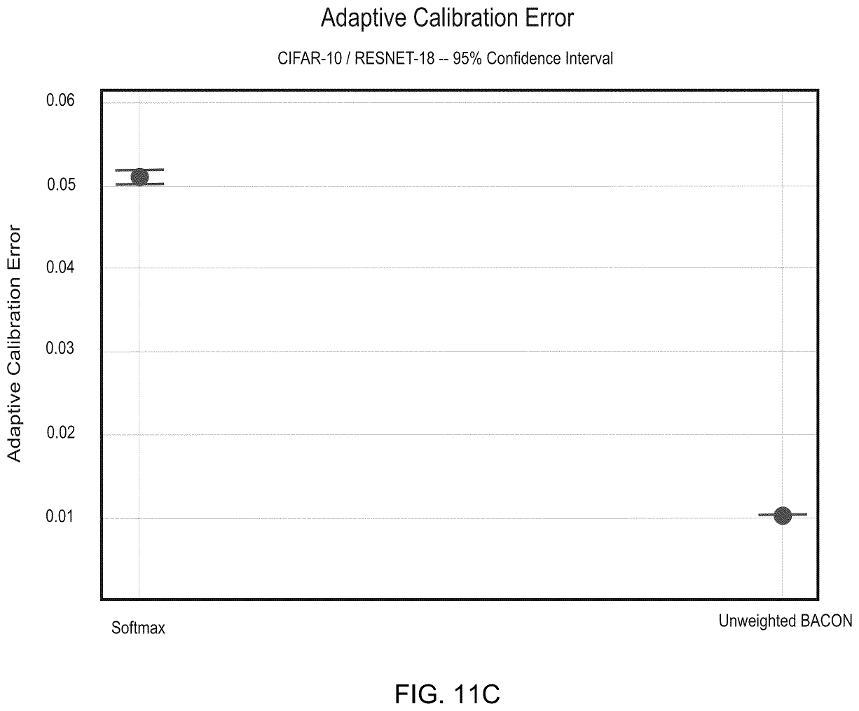

Referring to FIG. 11A, adaptive calibration error (ACE) values were compared for BACON v the Softmax function. Experimental conditions are ResNet-18 trained to about 85% accuracy on CIFAR-10 data. The evaluation was performed using a holdout imbalanced test data set 45. Under these conditions BACON significantly outperforms the Softmax function for estimating confidence.

Referring to FIG. 11B, ACE values were also calculated for BACON v the Softmax function at about 95% accuracy on CIFAR-10. The evaluation was performed using a holdout imbalanced test data set 45. Under these limited conditions BACON outperforms the Softmax function in estimating confidence. Referring to FIG. 11C, a display of about 95% confidence intervals of ACE for the Softmax function and BACON shows that the mean of observations lying within the error bars is considerably improved using BACON.

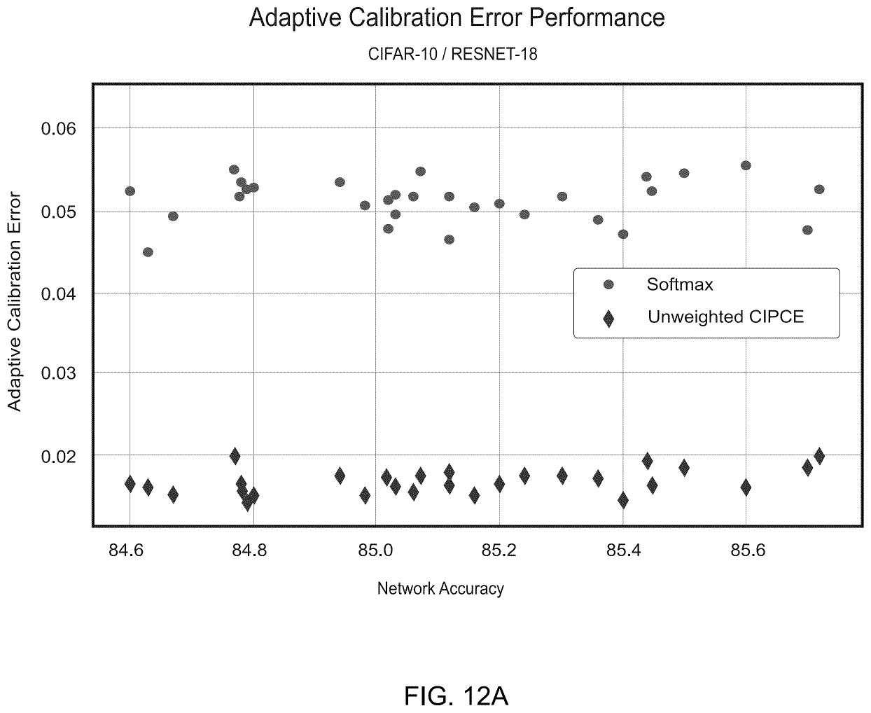

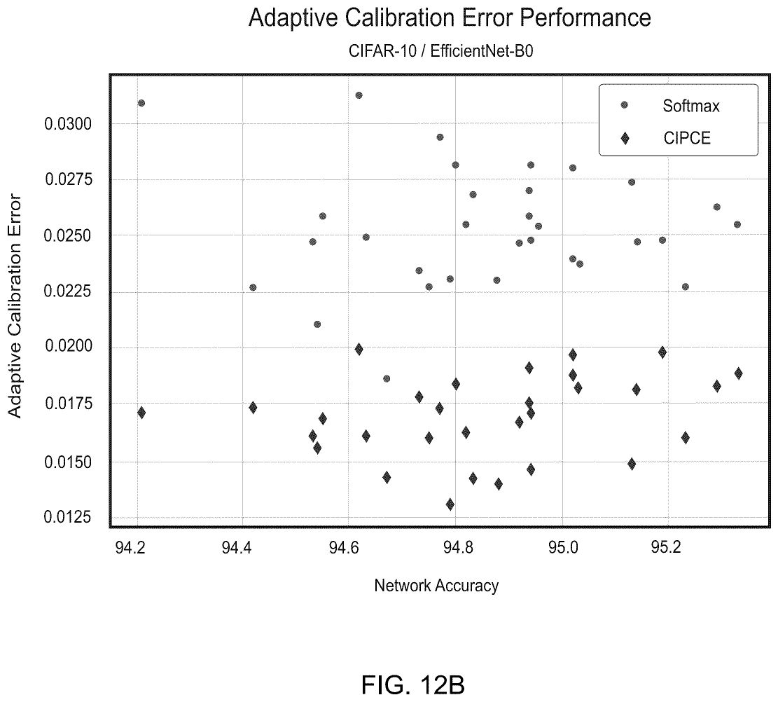

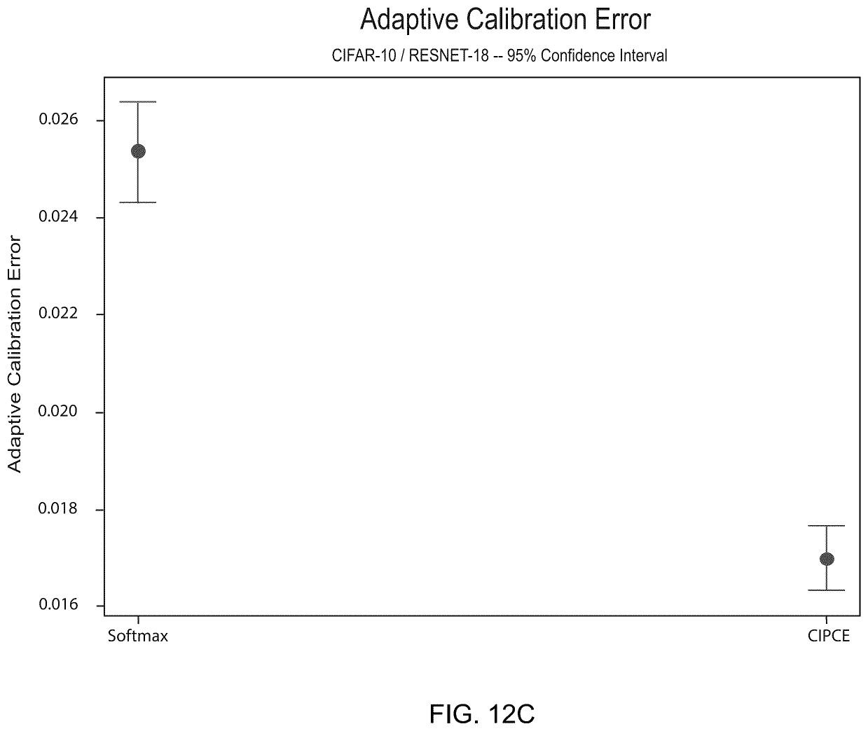

Referring to FIG. 12A, ACE values were also compared for CIPCE and the Softmax function using ResNet-18 trained to about 85% accuracy and evaluated on a CIFAR-10 holdout data set. Under these conditions CIPCE significantly outperformed the Softmax function for estimating confidence intervals.

Referring to FIG. 12B, ACE values were also compared for CIPCE and the Softmax function. The experiment conditions were EfficientNet-B0 trained to about 85% accuracy and evaluated on a CIFAR-10 holdout data set. The test data set 45 was imbalanced and CIPCE used a balanced set of weights 32. Under these conditions CIPCE significantly outperformed the Softmax function for estimating confidence intervals.

Referring to FIG. 12C, ACE confidence intervals were also compared for CIPCE and the Softmax function. The experiment conditions were EfficientNet-B0 trained to about 95% accuracy and evaluated on a CIFAR-10 holdout data set. The test data set 45 was imbalanced and CIPCE used a balanced set of weights 32. Under these conditions CIPCE significantly outperformed the Softmax function for estimating confidence intervals.

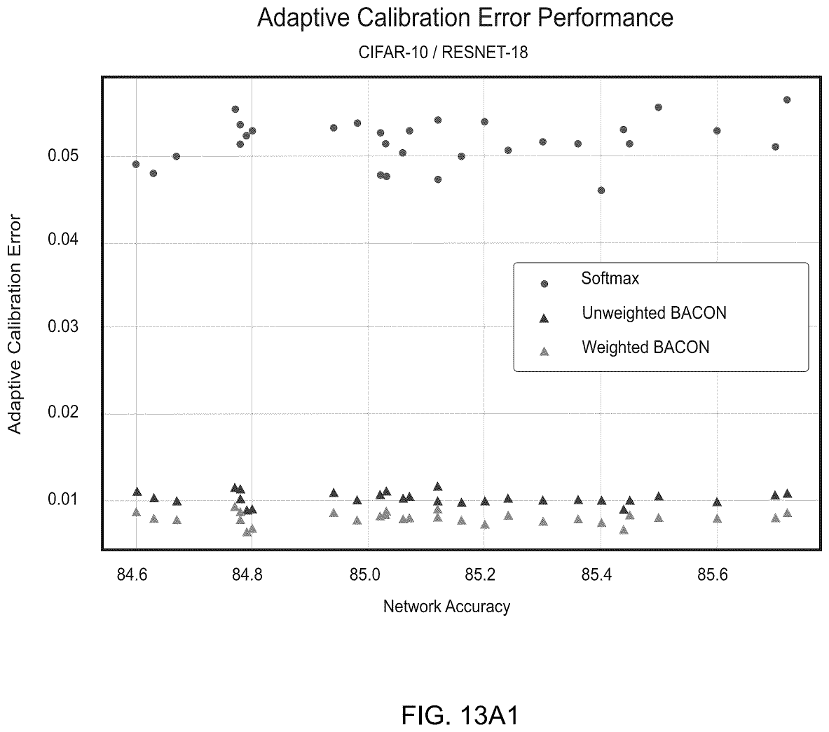

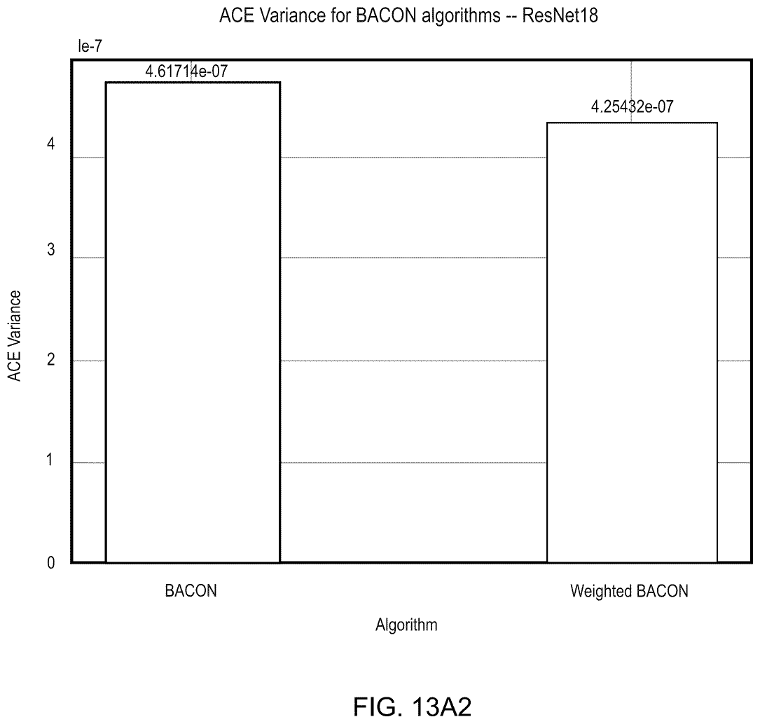

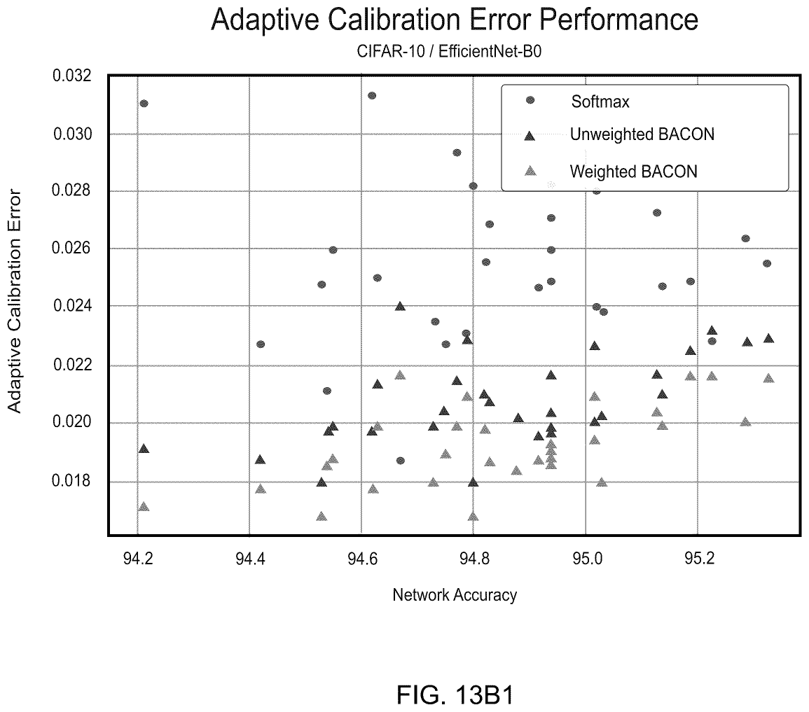

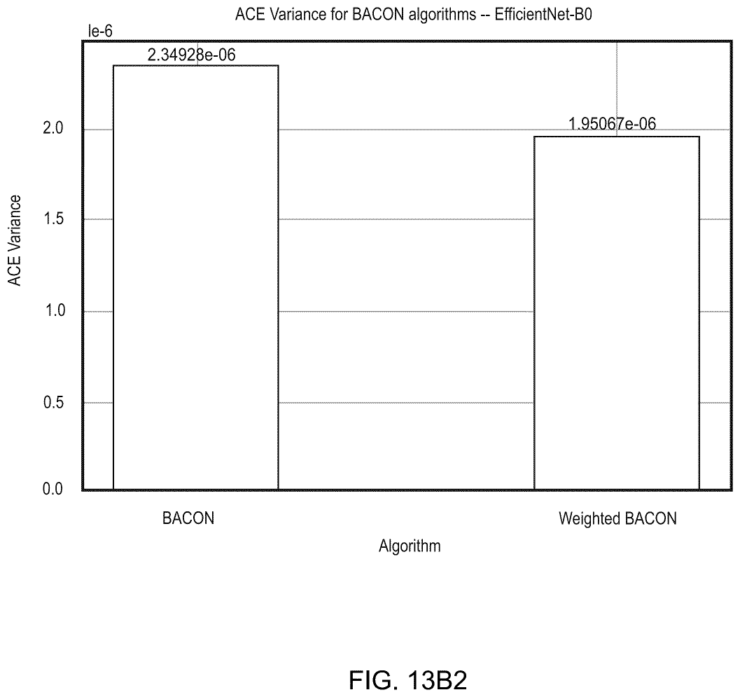

Referring to FIG. 13A1, and FIG. 13A2, furthermore, the BACON embodiment was analyzed using both unweighted and weighted estimates. Experiment conditions were ResNet-18 trained to about 85% accuracy on CIFAR-10 data. The evaluation was performed using a holdout test data set 45. The test data set 45 is weighted, and Weighted BACON used the actual weights 32 used to prepare the data set. In this data set, weight 32 for “dog” is 1, weight 32 for “cat” is 0.333, all other classes are weighted 0.666. Dog and cat classes were chosen due to the high degree of mutual confusion (members of each class mistaken as belonging to the other) between these classes. Weighting BACON estimates appears to provide improvement in variance about 7% over unweighted BACON estimates using CIFAR-10 data.

Referring to FIG. 13B1 and FIG. 13B2, the Adaptive Calibration Error (ACE) variance comparison for BACON vs Weighted BACON was also conducted using experimental conditions of EfficientNet-B0 trained to about 95% accuracy on CIFAR-10 data. Evaluation was performed using a holdout test data set 45. The test data set 45 was weighted, and Weighted BACON are the actual weights 32 used to prepare the data set. In this data set, weight 32 for “dog” is 1, weight 32 for “cat” is 0.333, all other classes are weighted 0.666. Dog and cat classes were chosen due to the high degree of mutual confusion (members of each class mistaken as belonging to the other) between these classes. Weighting the BACON estimates resulted in a 17% improvement in variance over unweighted BACON.

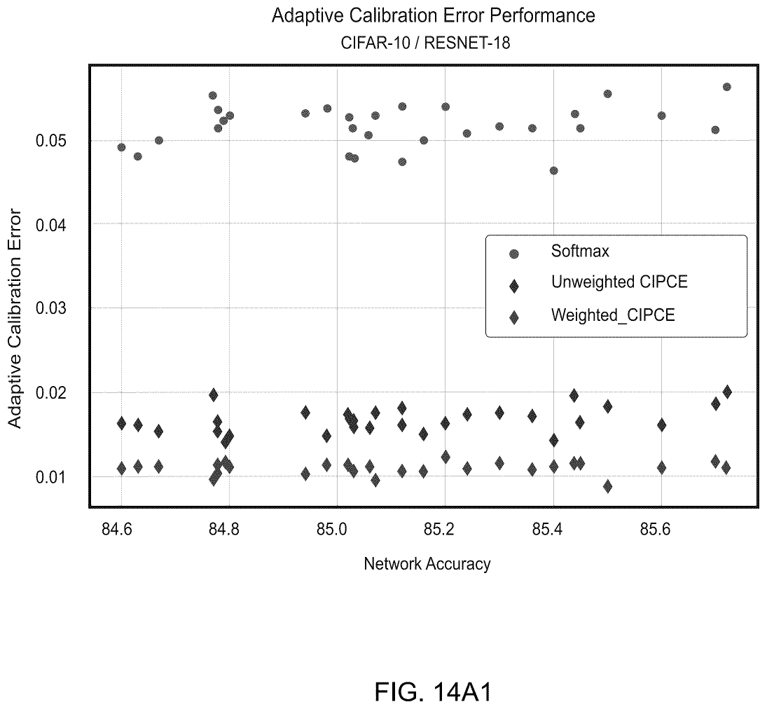

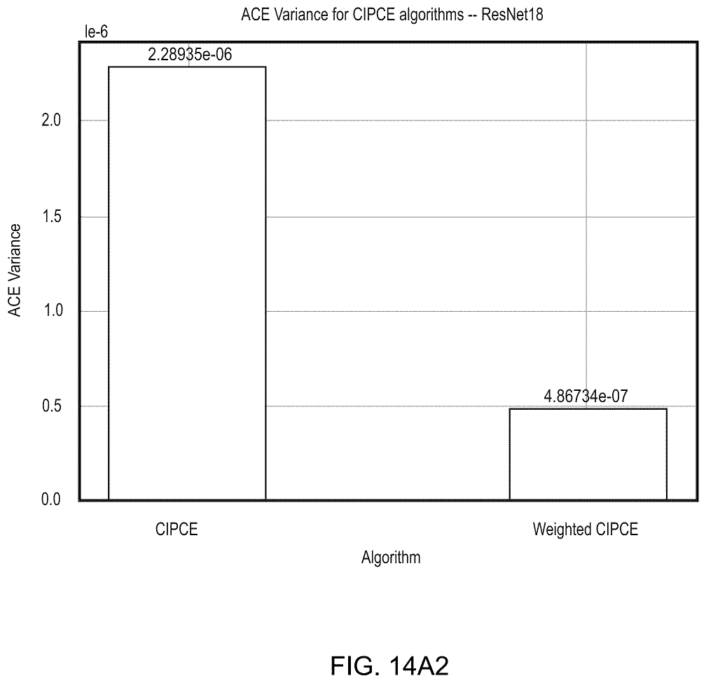

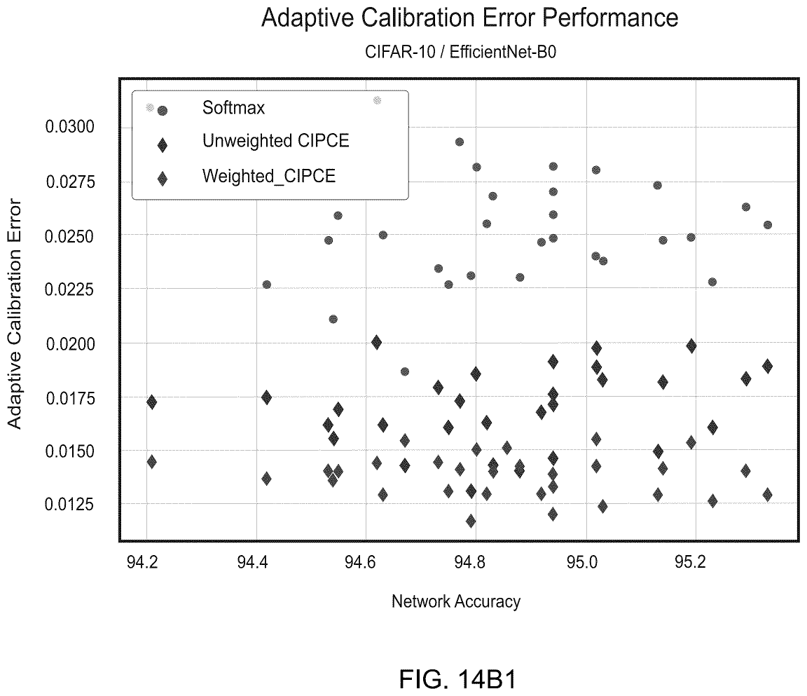

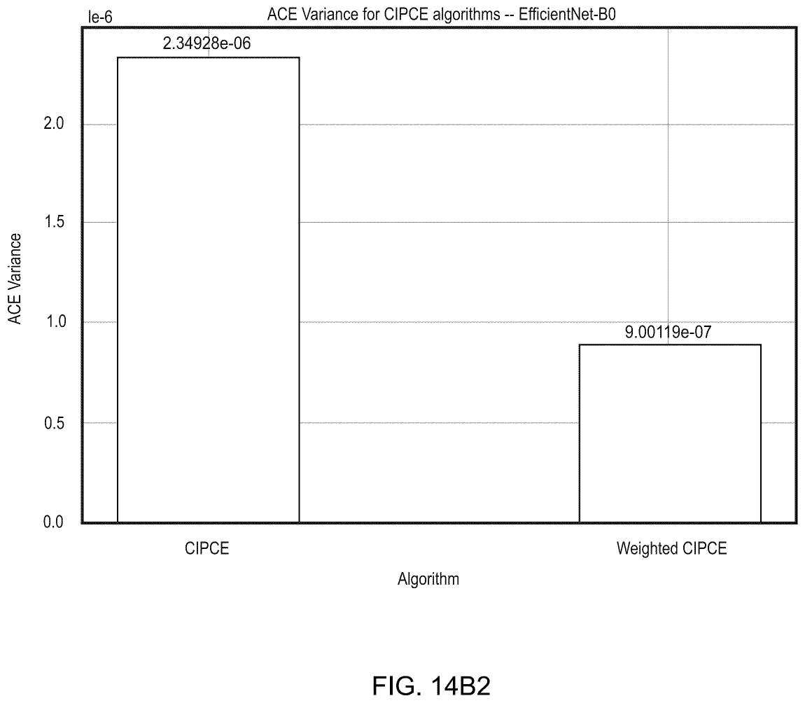

Referring to FIG. 14A1 and FIG. 14A2, the Adaptive Calibration Error (ACE) variance comparison for CIPCE vs Weighted CIPCE was also analyzed. Experiment conditions were ResNet-18 trained to about 85% accuracy on CIFAR-10 data. Evaluation was performed using a holdout test data set 45. Test data set is weighted, and Weighted CIPCE are the actual weights 32 used to prepare the data set. In this data set, weight 32 for “dog” is 1, weight 32 for “cat” is 0.333, all other classes are weighted 0.666. Dog and cat classes were chosen due to the high degree of mutual confusion (members of each class mistaken as belonging to the other) between these classes. Weighting CIPCE estimates appears to provide an improvement in variance of approximately 79% over unweighted CIPCE estimates.

Referring to FIG. 14B1 and FIG. 14B2, the Adaptive Calibration Error (ACE) variance comparison for CIPCE vs Weighted CIPCE was also analyzed using EfficientNet-B0 trained to about 95% accuracy on CIFAR-10 data. The evaluation was performed using a holdout test data set 45. The test data set 45 was weighted, and Weighted CIPCE are the actual weights 32 used to prepare the data set. In this data set, weight 32 for “dog” is 1, weight 32 for “cat” is 0.333, all other classes are weighted 0.666. Dog and cat classes were chosen due to the high degree of mutual confusion (members of each class mistaken as belonging to the other) between these classes. Weighting CIPCE estimates provides significant improvement over unweighted CIPCE mean values. In addition, weighting CIPCE estimates results in a 61% improvement in variance over unweighted CIPCE.

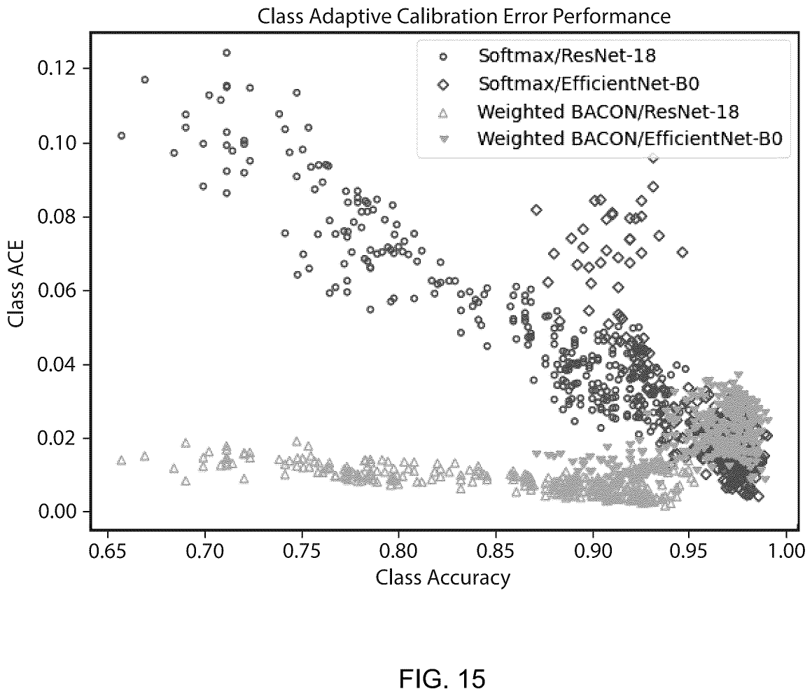

Referring to FIG. 15 the Adaptive Calibration Error (ECE) for Weighted BACON for individual classes was analyzed as a function of the classification accuracy for each class. This shows an interesting result, as the Softmax function calibration error increases at decreasing classification accuracy, while Weighted BACON is robust over the entire range of operating conditions. Importantly, Weighted BACON has significantly lower calibration error compared to the Softmax function at lower classification accuracies, where confidence estimation is more important than at higher classification accuracies.

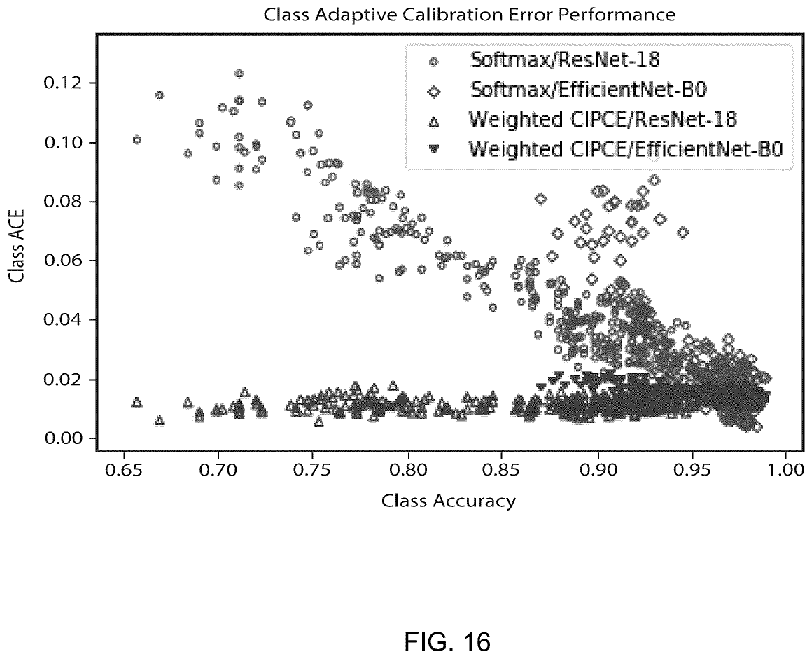

Referring to FIG. 16, the Adaptive Calibration Error (ACE) for Weighted CIPCE for individual classes was also analyzed as a function of the classification accuracy for each class. This shows a similar result to FIG. 15, where Weighted CIPCE is also robust over the entire range of operating conditions for this newer calibration error metric. Similarly to FIG. 15, Weighted CIPCE also has significantly lower calibration error compared to the Softmax function at lower classification accuracies, where confidence estimation is more important than at higher classification accuracies.

The Softmax function, is considered by one of skill to be the state of the art. The above figures show that that CIPCE unexpectedly outperforms Softmax function in all trials. Furthermore BACON unexpectedly outperforms Softmax function at about 85% accuracy.

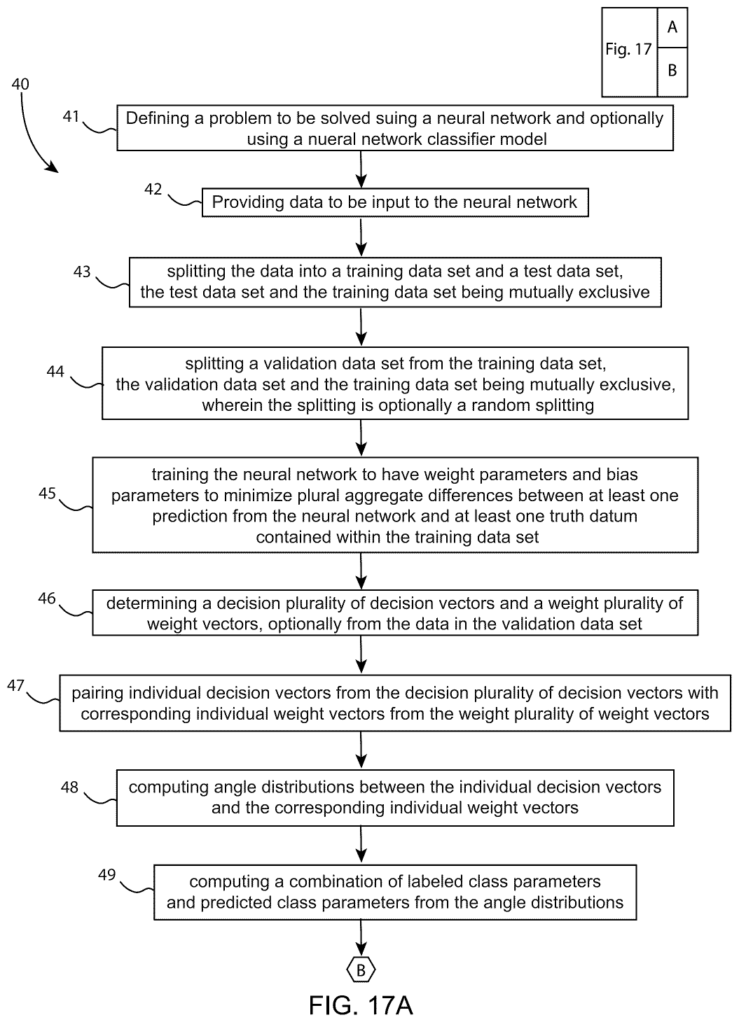

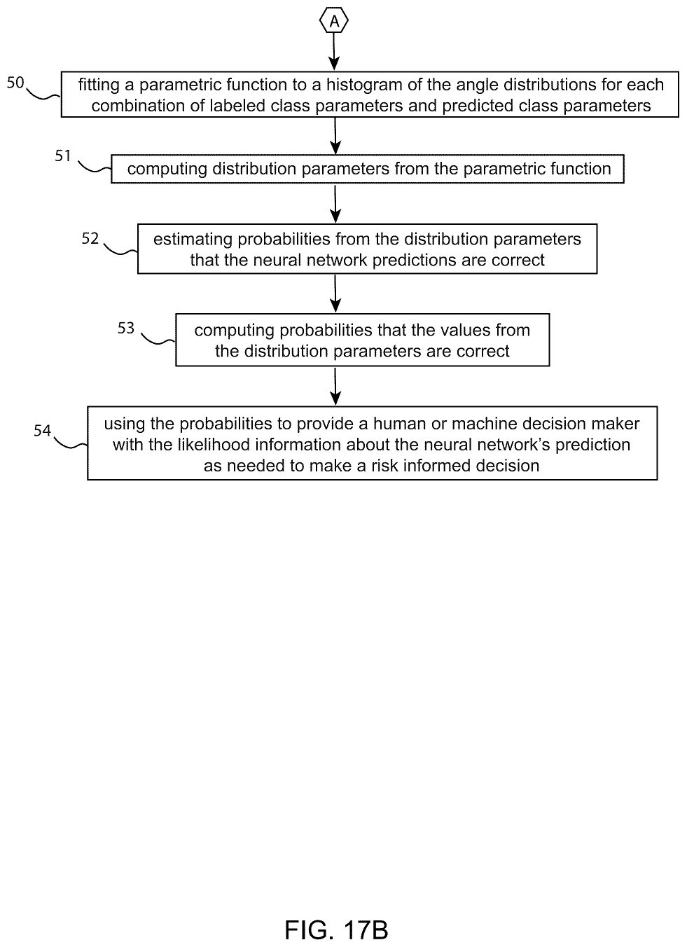

Referring to FIG. 17, in one embodiment the invention comprises a process 40 having the steps of defining a problem to be solved using a neural network and optionally using a neural network classifier model 41, providing data to be input to the neural network 42, splitting the data into a training data set and a test data set, the test data set and the training data set being mutually exclusive 43, splitting a validation data set from the training data set, the validation data set and the training data set being mutually exclusive, wherein the splitting is optionally a random splitting, 44 training the neural network to have weight parameters and bias parameters to minimize plural aggregate differences between at least one prediction from the neural network and at least one truth datum contained within the training data set 45, determining a decision plurality of decision vectors and a weight plurality of weight vectors, optionally from the data in the validation data set 46, pairing individual decision vectors from the decision plurality of decision vectors with corresponding individual weight vectors from the weight plurality of weight vectors 47, computing angle distributions between the individual decision vectors and the corresponding individual weight vectors 48, computing a combination of labelled class parameters and predicted class parameters from the angle distributions 49, fitting a parametric function to a histogram of the angle distributions for each combination of labeled class parameters and predicted class parameters 50, computing distribution parameters from the parametric function 51, estimating probabilities from the distribution parameters that the neural network predictions are correct 52, computing probabilities that the values from the distribution parameters are correct 53 and using the probabilities to provide a human or machine decision maker with the likelihood information about the neural network's prediction as needed to make a risk informed decision 54.

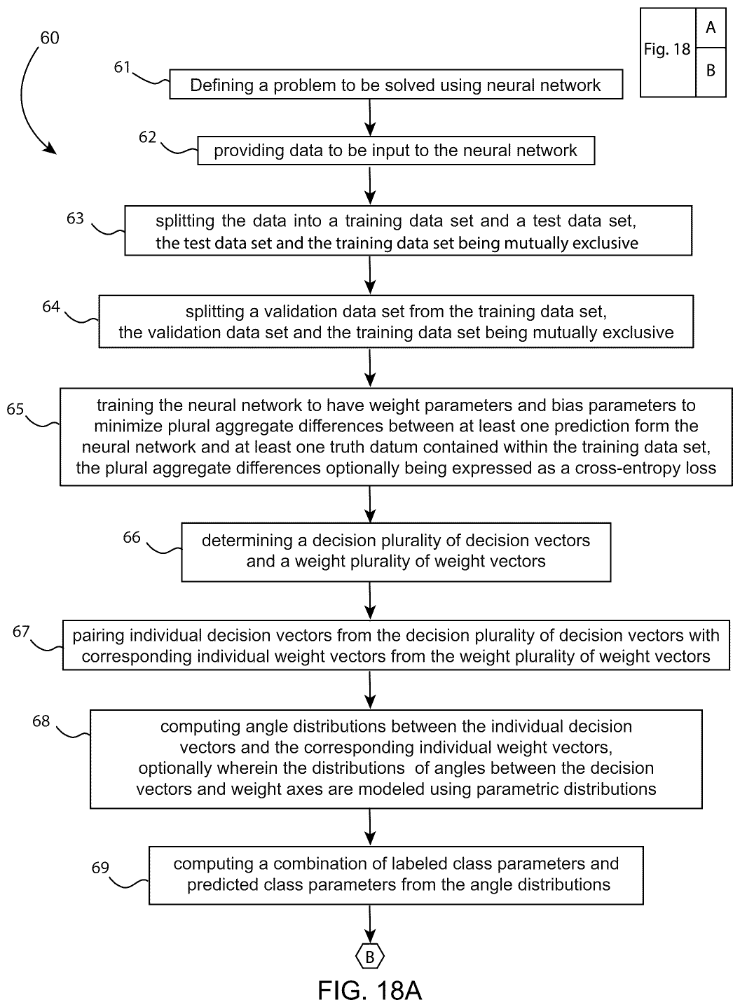

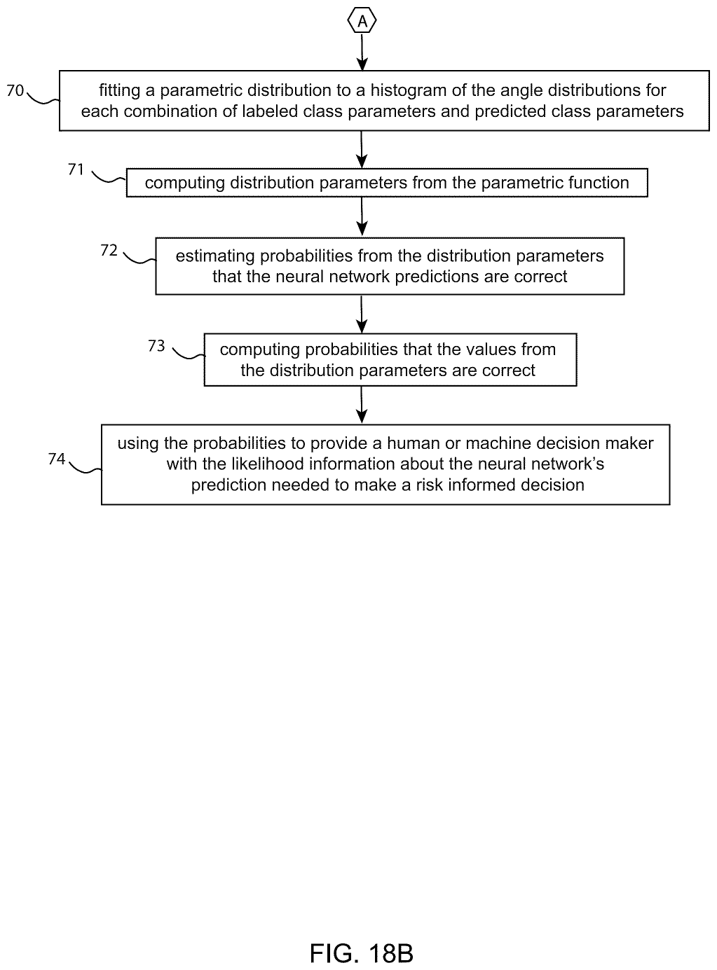

Referring to FIG. 18, in one embodiment the invention comprises a process 60 having the steps of defining a problem to be solved using a neural network 61, providing data to be input to the neural network 62, splitting the data into a training data set and a test data set the test data set and the training data set being mutually exclusive 63, splitting a validation data set from the training data set the validation data set and the training data set being mutually exclusive 64, training the neural network to have weight parameters and bias parameters to minimize plural aggregate differences between at least one prediction from the neural network and at least one truth datum contained within the training data set, the plural aggerate differences optionally being expressed as a cross-entropy loss 65, determining a decision plurality of decision vectors and a weight plurality of weight vectors 66, pairing individual decision vectors from the decision plurality of decision vectors with corresponding individual weight vectors from the weight plurality of weight vectors 67, computing angle distributions between the individual decision vectors and the corresponding individual weight vectors, optionally wherein the distributions of angles between the decision vectors and weight axes are modeled using parametric distributions 68, computing a combination of labelled class parameters and predicted class parameters from the angle distributions 69, fitting a parametric distribution to a histogram of the angle distributions for each combination of labeled class parameters and predicted class parameters 70, computing distribution parameters from the parametric function 71, estimating probabilities from the distribution parameters that the neural network predictions are correct 72, computing probabilities that the values from the distribution parameters are correct 73 and using the probabilities to provide a human or machine decision maker with the likelihood information about the neural network's prediction needed to make a risk informed decision 74.

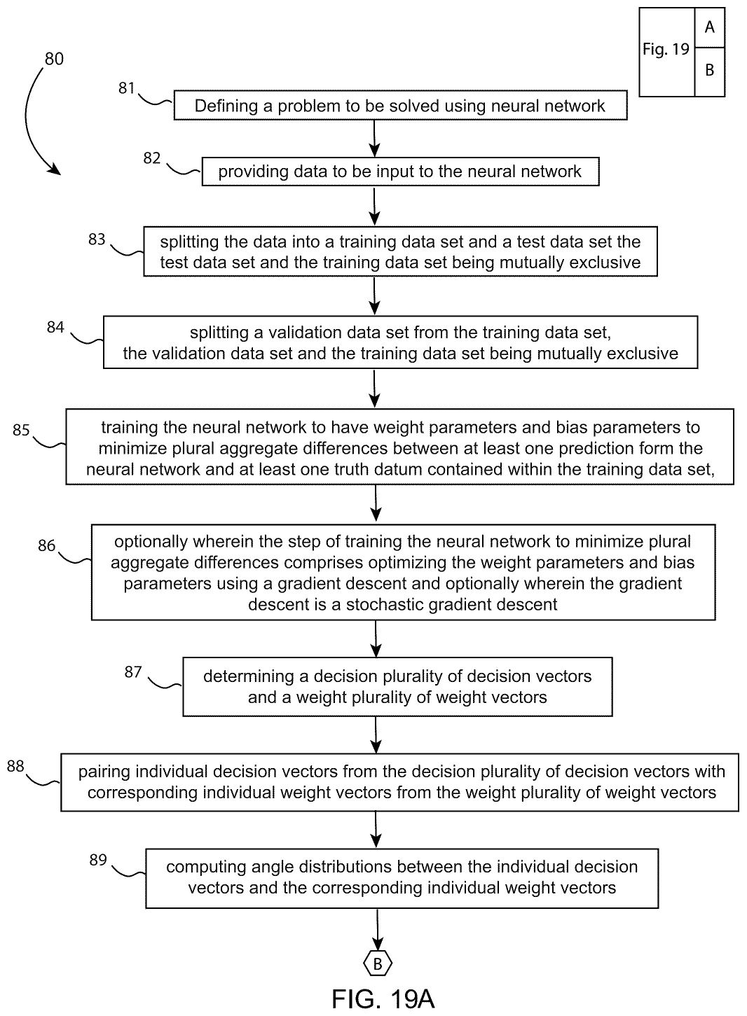

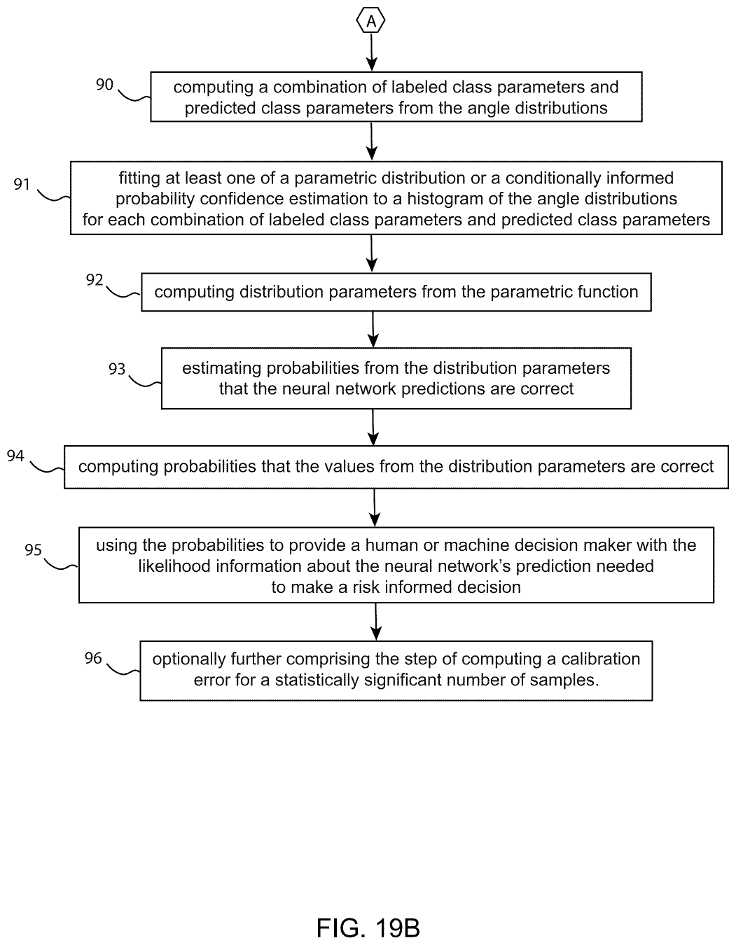

Referring to FIG. 19, in one embodiment the invention comprises a process 80 having the steps of defining a problem to be solved using a neural network 81, providing data to be input to the neural network 82, splitting the data into a training data set and a test data set, the test data set and the training data set being mutually exclusive 83, splitting a validation data set from the training data set, the validation data set and the training data set being mutually exclusive 84, training the neural network to have weight parameters and bias parameters to minimize plural aggregate differences between at least one prediction from the neural network and at least one truth datum contained within the training data set 85, optionally wherein the step of training the neural network to minimize plural aggregate differences comprises optimizing the weight parameters and bias parameters using a gradient descent and optionally wherein the gradient descent is a stochastic gradient descent 86, determining a decision plurality of decision vectors and a weight plurality of weight vectors 87, pairing individual decision vectors from the decision plurality of decision vectors with corresponding individual weight vectors from the weight plurality of weight vectors 88, computing angle distributions between the individual decision vectors and the corresponding individual weight vectors 89, computing a combination of labelled class parameters and predicted class parameters from the angle distributions 90, fitting at least one of a parametric distribution or a conditionally informed probability confidence estimation to a histogram of the angle distributions for each combination of labeled class parameters and predicted class parameters 91, computing distribution parameters from the parametric function 92, estimating probabilities from the distribution parameters that the neural network predictions are correct 93, computing probabilities that the values from the distribution parameters are correct 94, using the probabilities to provide a human or machine decision maker with the likelihood information about the neural network's prediction needed to make a risk informed decision 95, and optionally further comprising the step of computing a calibration error for a statistically significant number of samples 96.

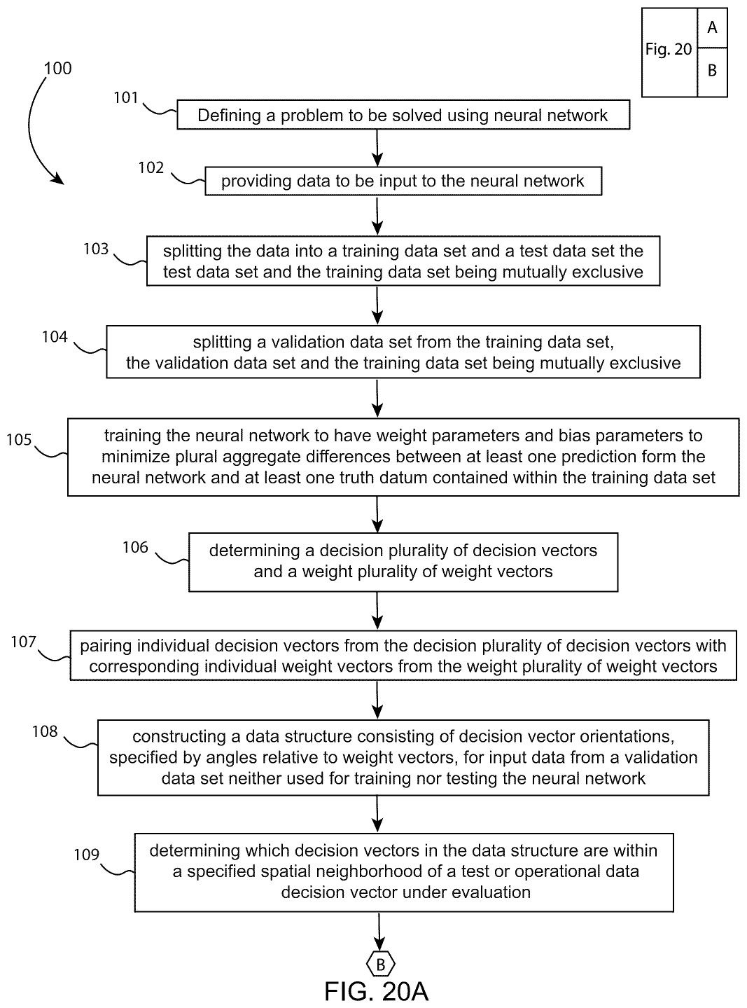

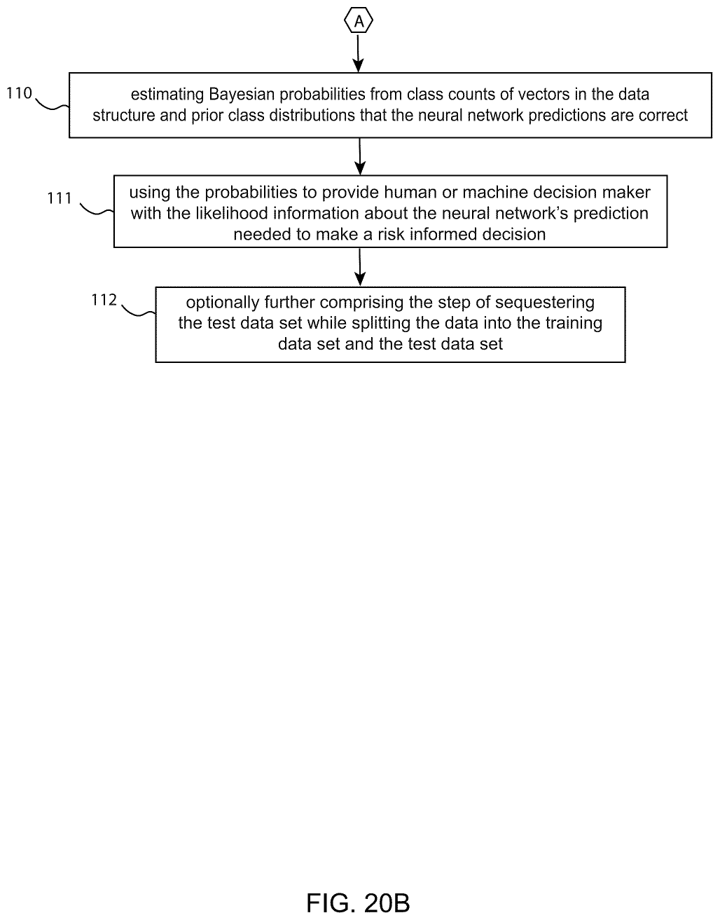

Referring to FIG. 20, in one embodiment the invention comprises a process 100 having the steps of defining a problem to be solved using a neural network 101, providing data to be input to the neural network102, splitting the data into a training data set and a test data set, the test data set and the training data set being mutually exclusive 103, splitting a validation data set from the training data set, the validation data set and the training data set being mutually exclusive 104, training the neural network to have weight parameters and bias parameters to minimize plural aggregate differences between at least one prediction from the neural network and at least one truth datum contained within the training data set 105, determining a decision plurality of decision vectors and a weight plurality of weight vectors 106, pairing individual decision vectors from the decision plurality of decision vectors with corresponding individual weight vectors from the weight plurality of weight vectors 107, constructing a data structure consisting of decision vector orientations, specified by angles relative to weight vectors, for input data from a validation data set neither used for training nor testing the neural network 108, determining which decision vectors in the data structure are within a specified spatial neighborhood of a test or operational data decision vector under evaluation 109, estimating Bayesian probabilities from class counts of vectors in the data structure and prior class distributions that the neural network predictions are correct 110, using the probabilities to provide a human or machine decision maker with the likelihood information about the neural network's prediction needed to make a risk informed decision 111 and optionally further comprising the step of sequestering the test data set while splitting the data into the training data set and the test data set 112.

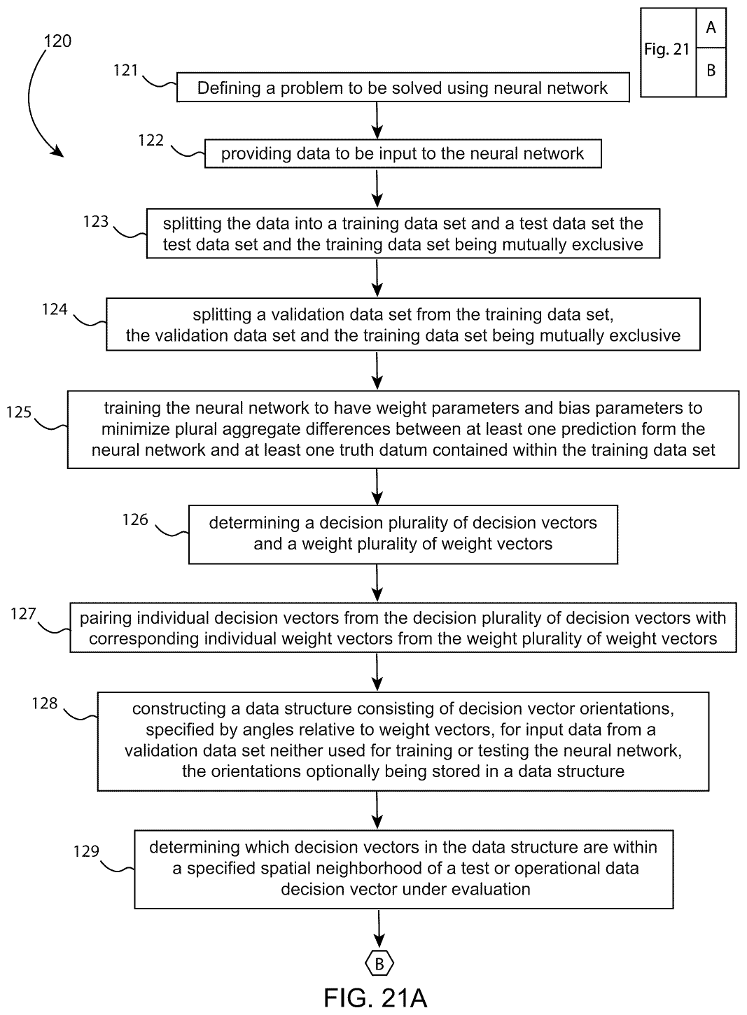

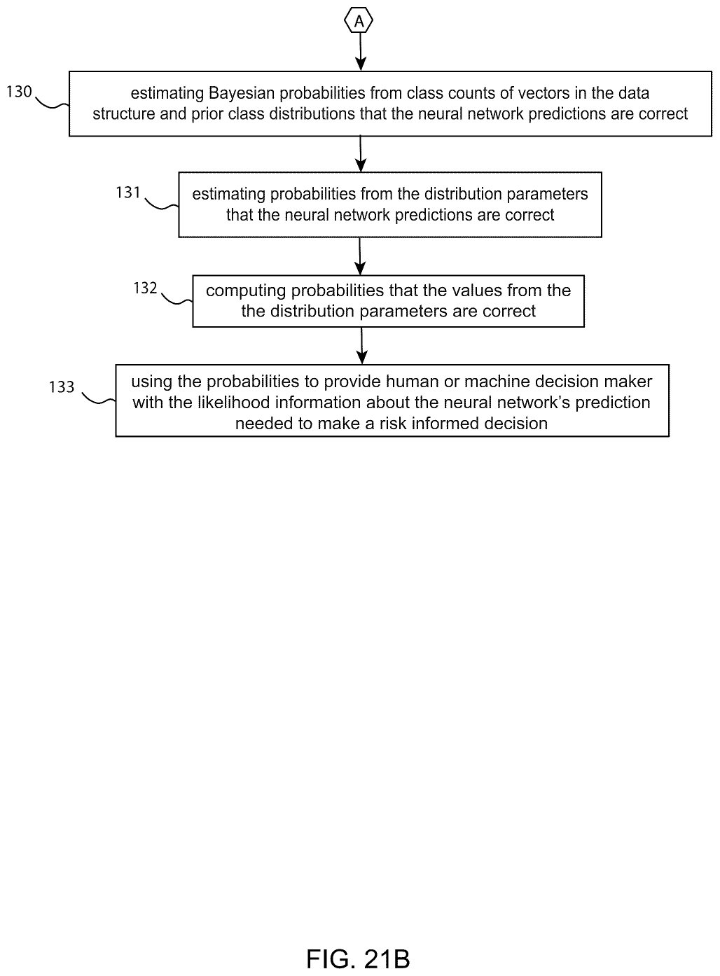

Referring to FIG. 21, in one embodiment the invention comprises a process 120 having the steps of defining a problem to be solved using a neural network 121, providing data to be input to the neural network 122, splitting the data into a training data set and a test data set, the test data set and the training data set being mutually exclusive 123, splitting a validation data set from the training data set the validation data set and the training data set being mutually exclusive 124, training the neural network to have weight parameters and bias parameters to minimize plural aggregate differences between at least one prediction from the neural network and at least one truth datum contained within the training data set 125, determining a decision plurality of decision vectors and a weight plurality of weight vectors 126, pairing individual decision vectors from the decision plurality of decision vectors with corresponding individual weight vectors from the weight plurality of weight vectors 127, constructing a data structure consisting of decision vector orientations, specified by angles relative to weight vectors for input data from a validation data set neither used for training or testing the neural network, the orientations optionally being stored in a data structure 128, determining which decision vectors in the data structure are within a specified spatial neighborhood of a test or operational data decision vector under evaluation 129, estimating Bayesian probabilities from class counts of vectors in the data structure and prior class distributions that the neural network predictions are correct 130, estimating probabilities from the distribution parameters that the neural network predictions are correct 131, computing probabilities that the values from the distribution parameters are correct 132 and using the probabilities to provide a human or machine decision maker with the likelihood information about the neural network's prediction needed to make a risk informed decision 133.

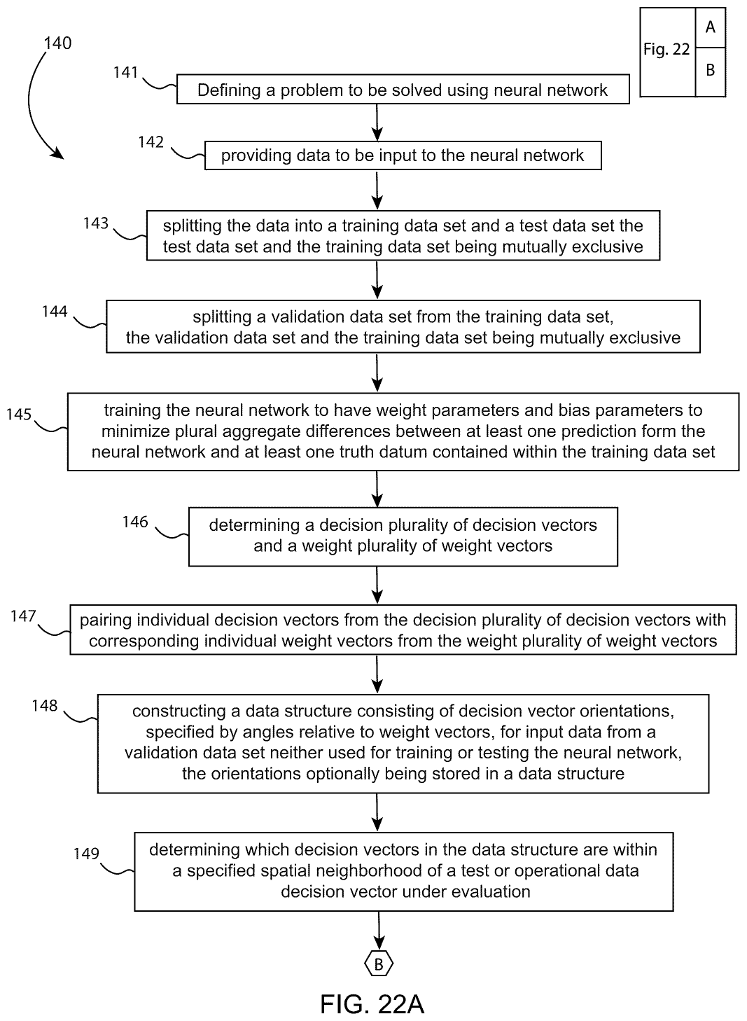

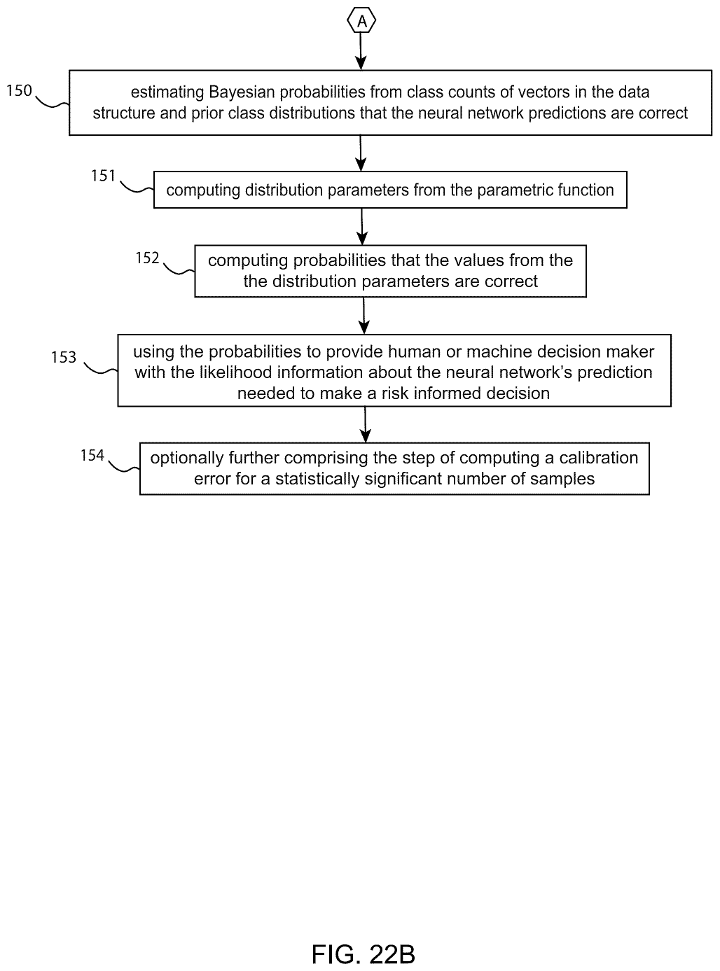

Referring to FIG. 22, in one embodiment the invention comprises a process 140 having the steps of defining a problem to be solved using a neural network 141, providing data to be input to the neural network 142, splitting the data into a training data set and a test data set, the test data set and the training data set being mutually exclusive 143, splitting a validation data set from the training data set, the validation data set and the training data set being mutually exclusive 144, training the neural network to have weight parameters and bias parameters to minimize plural aggregate differences between at least one prediction from the neural network and at least one truth datum contained within the training data set 145, determining a decision plurality of decision vectors and a weight plurality of weight vectors 146, pairing individual decision vectors from the decision plurality of decision vectors with corresponding individual weight vectors from the weight plurality of weight vectors 147, constructing a data structure consisting of decision vector orientations, specified by angles relative to weight vectors, for input data from a validation data set neither used for training or testing the neural network 148, determining which decision vectors in the data structure are within a specified spatial neighborhood of a test or operational data decision vector under evaluation 149, estimating Bayesian probabilities from class counts of vectors in the data structure and prior class distributions that the neural network predictions are correct 150, computing distribution parameters from the parametric function 151, computing probabilities that the values from the distribution parameters are correct 152, using the probabilities to provide a human or machine decision maker with the likelihood information about the neural network's prediction needed to make a risk informed decision 153 and optionally further comprising the step of computing a calibration error for a statistically significant number of samples 154.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern. All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A method of estimating the confidence in a neural network, the method comprising the steps of:
defining a problem to be solved using a neural network;
providing data to be input to the neural network;
splitting the data into a training data set and a test data set, the test data set and the training data set being mutually exclusive;
splitting a validation data set from the training data set, the validation data set and the training data set being mutually exclusive;
training the neural network to have weight parameters and bias parameters to minimize plural aggregate differences between at least one prediction from the neural network and at least one truth datum contained within the training data set;
determining a decision plurality of decision vectors and a weight plurality of weight vectors;
pairing individual decision vectors from the decision plurality of decision vectors with corresponding individual weight vectors from the weight plurality of weight vectors;
constructing a data structure consisting of decision vector orientations, specified by angles relative to weight vectors, for input data from a validation data set neither used for training or testing the neural network;
determining which decision vectors in the data structure are within a specified spatial neighborhood of a test or operational data decision vector under evaluation;
estimating at least one Bayesian probability from a plurality of class counts of vectors in the data structure and a plurality of prior class distributions that the neural network predictions are correct; and
using the at least one Bayesian probability set to provide a human or a machine decision maker with the likelihood information about the neural network's prediction needed to make a risk informed decision.

2. A method according to claim 1 wherein the step of splitting the data into a training data set and a test data set comprises randomly splitting the data.

3. A method according to claim 1 further comprising the step of sequestering the test data set while splitting the data into the training data set and the test data set.

4. A method according to claim 1 wherein the step of determining the decision plurality of decision vectors and the weight plurality of weight vectors comprises making the determinations from data in the validation data set.

5. A method according to claim 1 wherein the decision vector spatial orientations are saved in a data structure for later reference to be used to estimate probabilities for test or operational data.

6. A method according to claim 1 wherein the problem is defined using a neural network classifier model.

7. A method according to claim 6 wherein the neural network classifier model defines a type of data input and a plurality of classes of the data input.

8. A method according to claim 7 wherein the type of data comprises visual images.

9. A method of estimating the probabilities of correct values from a neural network, the method comprising the steps of:
defining a problem to be solved using a neural network;
providing data to be input to the neural network;
splitting the data into a training data set and a test data set, the test data set and the training data set being mutually exclusive;
splitting a validation data set from the training data set, the validation data set and the training data set being mutually exclusive;
training the neural network to have plural weight parameters and plural bias parameters to minimize plural aggregate differences between at least one prediction from the neural network and at least one truth datum contained within the training data set;
determining a decision plurality of decision vectors and a weight plurality of weight vectors;
pairing individual decision vectors from the decision plurality of decision vectors with corresponding individual weight vectors from the weight plurality of weight vectors;
constructing a data structure consisting of decision vector orientations, specified by angles relative to weight vectors, for input data from a validation data set neither used for training or testing the neural network.
determining which decision vectors in the data structure are within a specified spatial neighborhood of a test or operational data decision vector under evaluation;
estimating Bayesian probabilities from class counts of vectors in the data structure and prior class distributions that the neural network predictions are correct;
estimating at least one value from the distribution parameters that the neural network predictions are correct;
computing at least one probability that the at least one value from the distribution parameters are correct; and
using the at least one probability to provide a human or a machine decision maker with the likelihood information about the neural network's prediction needed to make a risk informed decision.

10. A method according to claim 9 wherein the orientation of decision vectors relative to the weight vectors are stored in a data structure.

11. A method according to claim 9 wherein the plural aggregate differences are expressed as a cross-entropy loss.

12. A method according to claim 9 wherein the type of data comprises visual images.

13. A method of estimating the probabilities of correct values from a neural network, the method comprising the steps of:
defining a problem to be solved using a neural network;
providing data to be input to the neural network;
splitting the data into a training data set and a test data set, the test data set and the training data set being mutually exclusive;
splitting a validation data set from the training data set, the validation data set and the training data set being mutually exclusive;
training the neural network to have weight parameters and bias parameters to minimize plural aggregate differences between at least one prediction from the neural network and at least one truth datum contained within the training data set;
determining a decision plurality of decision vectors and a weight plurality of weight vectors;
pairing individual decision vectors from the decision plurality of decision vectors with corresponding individual weight vectors from the weight plurality of weight vectors;
constructing a data structure consisting of decision vector orientations, specified by angles relative to weight vectors, for input data from a validation data set neither used for training or testing the neural network.
determining which decision vectors in the data structure are within a specified spatial neighborhood of a test or operational data decision vector under evaluation;
estimating a plurality of conditionally informed probability confidence estimation probabilities from at least one class count of vectors in the data structure and at least one prior class distribution that the neural network predictions are correct;
computing plural distribution parameters from the parametric function;
computing plural probabilities that the values from the plural distribution parameters are correct; and
using the plural probabilities to provide a human or a machine decision maker with the likelihood information about the neural network's prediction needed to make a risk informed decision.

14. A method according to claim 13 further comprising the step of computing a calibration error for at least one of the estimated probability.

15. A method according to claim 14 wherein the step of computing a calibration error comprises computing the calibration error comprises computing the calibration error for a statistically significant number of samples.

16. A method according to claim 14 wherein the step of minimizing plural aggregate differences comprises optimizing the weight parameters and bias parameters using a gradient descent.

17. A method according to claim 15 wherein the gradient descent is a stochastic gradient descent.

18. A method according to claim 16 wherein the step of training the neural network is terminated when the aggregate differences for the validation data set reach a minimum value, in order to avoid overfitting the model.

19. A method according to claim 13 wherein the conditionally informed probability confidence estimation uses Bayes' rule.

20. A method according to claim 13 further comprising the step of providing a human or machine decision maker with the likelihood information about the neural network's prediction needed to make a risk informed decision.
